(19) United States
(12) Patent Application Publication
(10) Pub. No.: US 2011/0017938 A1
(43) Pub. Date: Jan. 27, 2011

(54) HALF-METALLIC ANTIFERROMAGNETIC MATERIAL

(75) Inventors: Hisazumi Akai, Osaka (JP); Masako Ogura, Osaka (JP); Long Hoang Nguyen, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OSAKA UNIVERSITY, Suita-shi, Osaka (JP)

(21) Appl. No.: 12/933,744

(22) PCT Filed: Mar. 18, 2009
(86) PCT No.: PCT/JP2009/055242

§ 371 Date: Sep. 21, 2010

(30) Foreign Application Priority Data
Mar. 21, 2008 (JP) 2008-073917

(51) Int. Cl. H01F 1/00

(52) U.S. Cl. 252/62.51 C; 252/62.51 R

(57) ABSTRACT

A half-metallic antiferromagnetic material according to the present invention is a compound that has a crystal structure of a nickel arsenic type, a zinc blende type, a wurtzite type, a chalcopyrite type or a rock salt type and is constituted of two or more magnetic elements and a chalocogen or a pnictogen. The two or more magnetic elements contain a magnetic element having fewer than 5 effective d electrons and a magnetic element having more than 5 effective d electrons, and a total number of effective d electrons of the two or more magnetic elements is 10 or a value close to 10.

### TECHNICAL FIELD

The present invention relates to a half-metallic antiferromagnetic material that has an antiferromagnetic property and exhibits, among electron spin-up and spin-down states, in one electron spin state, a property as a metal and, in the other electron spin state, a property as an insulator or a semiconductor.

### BACKGROUND ART

A half-metallic antiferromagnetic property is a concept first proposed by van Leuken and de Groot (see Non-Patent Literature 1), and a half-metallic antiferromagnetic material is a substance that exhibits a property as a metal in one electron spin state of electron spin-up and spin-down states and a property as an insulator or a semiconductor in the other electron spin state.

As a half-metallic antiferromagnetic material as described above, various substances have conventionally been proposed. For example, Pickett calculated electronic states of Sr₂VCuO₆, La₂MnVO₆ and La₂MnCoO₆ that have a double perovskite structure, and predicted that, among these intermetallic compounds, La₂MnVO₆ has a likelihood of exhibiting a half-metallic antiferromagnetic property (see Non-Patent Literature 2).

Furthermore, the present inventors have proposed various antiferromagnetic half-metallic semiconductors having a semiconductor as a host (see Non-Patent Literatures 3 to 7) and have applied for their patents (see Patent Literatures 1 and 2). The antiferromagnetic half-metallic semiconductors that the present inventors have proposed can be obtained by substituting, for example, a group II atom of a group II-VI compound semiconductor or a group III atom of a group III-V compound semiconductor with two or more magnetic ions. Specifically, examples thereof include (ZnCrFe)S, (ZnVCo)S, (ZnCrFe)Se, (ZnVCo)Se, (GaCrNi)N and (GaMnCo)N.
Non-Patent Literature 1: van Leuken and de Groot, Phys. Rev. Lett. 74, 1171 (1995)
Non-Patent Literature 2: W. E. Pickett, Phys. Rev. B57, 10613 (1998)
Non-Patent Literature 3: H. Akai and M. Ogura, Phys. Rev. Lett. 97, 06401 (2006)
Non-Patent Literature 4: M. Ogura, Y. Hashimoto and H. Akai, Physica Status Solidi C3, 4160 (2006)
Non-Patent Literature 5: M. Ogura, C. Takahashi and H. Akai, Journal of Physics: Condens. Matter 19, 365226 (2007)
Non-Patent Literature 6: H. Akai and M. Ogura, Journal of Physics D: Applied Physics 40, 1238 (2007)
Non-Patent Literature 7: H. Akai and M. Ogura, HyperfineInterractions (2008) in press
Patent Literature WO2006/028299
Patent Literature 2: Japanese Patent Application No. 2006-219951

### DISCLOSURE OF THE INVENTION

### Problems to be Solved by the Invention

However, as a result of a study conducted by the present inventors, it was found that an intermetallic compound La₂MnVO₆ predicted by Pickett to be likely to exhibit the half-metallic antiferromagnetic property is low in the likelihood of developing the half-metallic antiferromagnetic property and, even when the half-metallic antiferromagnetic property is developed, it is low in the likelihood of being a stable magnetic structure. Furthermore, in the antiferromagnetic half-metallic semiconductor with a semiconductor as a host, a strong attractive interaction exists between magnetic ions; accordingly, magnetic ions form clusters in the host or two-phase separation is caused in an equilibrium state to result in a state where magnetic ions are precipitated in the host. Accordingly, a problem is that it is difficult to assemble a crystal state and to be chemically stable. Another problem is that owing to weak chemical bond, the magnetic coupling is weak and the magnetic structure is unstable.

In this connection, an object of the present invention is to provide a half-metallic antiferromagnetic material that is chemically stable and has a stable magnetic structure.

### Means for Solving the Problems

A half-metallic antiferromagnetic material according to the present invention is a compound that has a crystal structure of a nickel arsenic type, a zinc blende type, a wurtzite type, a chalcopyrite type or a rock salt type and is constituted of two or more magnetic elements and a chalocogen or a pnictogen, the two or more magnetic elements containing a magnetic element having fewer than 5 effective d electrons and a magnetic element having more than 5 effective d electrons, a total number of effective d electrons of the two or more magnetic elements'being 10 or a value close to 10.

The number of effective d electrons of a magnetic element is a number obtained by subtracting the number of electrons that a chalcogen or a pnictogen loses for covalent bonding or ionic bonding, that is, the number of ionic valency, from the number of all valence electrons of the magnetic element. The number of all valence electrons of a magnetic element is a value-obtained by subtracting the number of core electrons (18 in a 3d transition metal element) from the number of electrons in the atom (atomic number). For example, since a chalcogen is divalent, the numbers of effective d electrons of Cr (atomic number: 24) and Fe (atomic number: 26) are four (=24−18−2) and 6 (=26−18−2), respectively. Furthermore, since the pnictogen is trivalent, the numbers of effective d electrons of Mn (atomic number: 25) and Co (atomic number: 27) are four (=25−18−3) and 6 (=27−18−3), respectively.

Furthermore, the total number of effective d electrons of two or more magnetic elements can be obtained also as shown below. For example, in a half-metallic antiferromagnetic material represented by a composition formula ABX₂ (A and B each represent a magnetic element and X represents a chalcogen), the number of valence electrons that the chalcogen X supplies to a bond state owing to sp electrons is 12 (=6×2), and, in a bond state owing to sp electrons, 16 (=8×2) valence electrons per chemical formula weight are accommodated. Accordingly, since four electrons (=16−12) are supplied from magnetic elements A and B to the bond state, a value obtained by subtracting four that is the number of the electrons from the total of the number of all valence electrons of the magnetic element A and the number of all valence electrons of the magnetic element B is the total number of effective d electrons. In the case where the magnetic element A is Cr (atomic number: 24) and the magnetic element B is Fe (atomic number: 26), since the number of all valence electrons of the magnetic element A is 6 (=24−18) and the number of all valence electrons of the magnetic element B is 8 (=26−18), the total number of all valence electrons is 14 and the total number of effective d electrons of the magnetic elements A and B is 10 (=14−4). On the other hand, in a half-metallic antiferromagnetic material where in the composition formula ABX₂, X is a pnictogen, since the number of valence electrons that the pnictogen X supplies to a bond state owing to Sp electrons is 10 (=5×2), a value obtained by subtracting a number of the electrons of 6 from the total of the number of all valence electrons of the magnetic element A and the number of all valence electrons of the magnetic element B is the total number of effective d electrons.

Furthermore, also in a half-metallic antiferromagnetic material constituted of three or more magnetic elements and a chalcogen or a pnictogen, for example, a half-metallic antiferromagnetic material represented by a composition formula (ABC)X₂ (A, B and C each represent a magnetic element), in a manner similar to a half-metallic antiferromagnetic material constituted of two magnetic elements and a chalcogen or a pnictogen, a total number of effective d electrons can be obtained. Still furthermore, also in a half-metallic antiferromagnetic material where (AC)X₂ and (BC)X₂ each form a solid solution like (A_{0.5}B_{0.5}C)X₂, in a manner similar to the above, a total number of effective d electrons can be obtained. For example, in the case where the magnetic element A represents V, the magnetic element B represents Mn and the magnetic element C represents Fe and X represents a chalcogen, the total number of all valence electrons of the magnetic elements A, B and C is 14 (=5×0.5+7×0.5+8) and the total number of effective d electrons of the magnetic elements A, B and C is 10.

The reason why the compound according to the present invention develops a half-metallic antiferromagnetic property is considered as follows. In the following description, a case where two magnetic elements are contained will be described.

In a nonmagnetic state of a compound represented by a composition formula ABX₂ (A and B each represent a magnetic element and X represents a chalcogen or a pnictogen), as shown in FIG. 38, a bonding sp state and an antibonding sp state that s states and p states of the magnetic element A and magnetic element B form together with an s state and a p state of the element X each form a band and therebetween a band made of a d state of the magnetic element A and a d state of the magnetic element B is formed.

A d orbital of the magnetic element A and a d orbital of the magnetic element B are spin split owing to an interelectronic interaction. At that time, as a magnetic state, a state where a local magnetic moment of the magnetic element A and a local magnetic moment of the magnetic element B are aligned in parallel with each other and a state where a local magnetic moment of the magnetic element A and a local magnetic moment of the magnetic element B are aligned in antiparallel with each other are considered. In addition, a paramagnetic state where local magnetic moments are aligned in arbitrary directions and also other complicated states can be considered. However, it is enough only to study two states where local magnetic moments are aligned in parallel and in antiparallel with each other.

In a state where a local magnetic moment of the magnetic element A and a local magnetic moment of the magnetic element B are aligned in parallel with each other, as shown in FIG. 39, a band (d band) made of a d state is exchange split to exhibit a band structure of a typical ferromagnetic material. Here, an energy gain when local magnetic moments are aligned in parallel with each other is generated by a slight expansion of the band, and the expansion of the band is generated by hybridizing a d state of the magnetic element A and a d state of the magnetic element B, which are different in energy. To generate a band energy gain by hybridizing between different energy states is called a superexchange interaction. When a hopping integral that represents an intensity of hybridization of d states between the magnetic element A and the magnetic element B is assigned to t, an energy gain E1 obtained by aligning local magnetic moments in parallel with each other is represented by a following numerical expression 1.

E1=−|t|²/D (Formula 1)

In the above, D represents an energy difference of d orbitals of the magnetic elements A and B and takes a larger value as the difference of the numbers of effective d electrons between the magnetic element A and the magnetic element B becomes larger.

On the other hand, in a state where a local magnetic moment of the magnetic element A and a local magnetic moment of the magnetic element B are aligned in antiparallel with each other, as shown in FIG. 40, a band made of d states is spin split to exhibit a band structure different from a state where local magnetic moments are aligned in parallel. An energy gain when local magnetic moments are aligned in antiparallel with each other is generated when d states of the magnetic element A and magnetic element B energetically degenerated in a spin-up band are strongly hybridized to form a bonding d state and an antibonding d state and electrons mainly occupy the bonding d state. Thus, to obtain a band energy gain by hybridizing between energetically degenerated states is called a double exchange interaction. An energy gain E2 owing to the double exchange interaction is proportional to −t when the hopping integral is represented by t. Furthermore, in a spin-down band, in a manner similar, to the case of the ferromagnetic property, an energy gain owing to the superexchange interaction is generated.

While an energy gain due to the superexchange interaction is proportional to a square of the hopping integral t (secondary perturbation), an energy gain due to the double exchange interaction is linearly proportional to the hopping integral t (primary perturbation when degeneration is caused). Accordingly, in general, a larger energy gain is generated by the double exchange interaction than by the superexchange interaction. In order to generate the double exchange interaction, d states have to be degenerated, and, in a state where local magnetic moments are aligned in antiparallel with each other, when a total number of effective d electrons of the magnetic element A and the number of effective d electrons of the magnetic element B is 10 that is the number of maximum occupying electrons of a 3d electron orbital or a value close to 10, such degeneracy is caused.

As mentioned above, when a total number of effective d electrons is 10 or a value close to 10, a case where local magnetic moments of A and B are aligned in antiparallel with each other is advantageous from energy point of view. Furthermore, in a spin-down band that is subjected to an effect of large exchange splitting corresponding to twice the ferromagnetic exchange splitting, as shown in FIG. 40, a large gap is generated and a Fermi energy locates in the vicinity of a center of an energy gap.

Furthermore, a zinc blende type crystal structure, a wurtzite type crystal structure and a chalcopyrite type crystal structure, which are strong in covalent property, are 4-coordinated and a nickel arsenic type crystal structure and a rock salt type crystal structure, which have an ionic property, are 6-coordinated, and all crystal structures form a strong chemical bond. However, concerning an s-state or a e-state, a substance having a crystal structure of 4-coordination is smaller in bonding/antibonding splitting to have a semiconductive property, and a substance having a crystal structure of 6-coordination has a more insulative property. A band made of a d-state of the magnetic element comes in a region where a band gap was originally present. Among a spin-up band and a spin-down band, in one spin band, an original band gap remains to develop a half-metallic property. Furthermore, although a d-state of the magnetic element is hybridized with surrounding negative ions, a property of a d-state as an atomic orbital is retained and stable antiferromagnetic property is developed with large magnetic splitting and local magnetic moment remained.

From what was mentioned above, a compound according to the present invention can be said high in the likelihood of developing a half-metallic antiferromagnetic property in a ground state. It is confirmed by a first principle electronic state calculation as will be described below that a half-metallic antiferromagnetic property is developed in a compound according to the present invention.

In addition, in the case where a total number of effective d electrons of two magnetic elements is a value close to 10, since magnitudes of magnetic moments of both magnetic elements are slightly different, it is considered to develop a ferrimagnetic property having a slight magnetic property as a whole. However, in claims and a specification of the present application, “a ferrimagnetic material” is included in “an antiferromagnetic material”.

The half-metallic antiferromagnetic material according to the present invention is not a state where magnetic ions precipitate in a host like a half-metallic antiferromagnetic semiconductor with a semiconductor as a host but a compound obtained by chemically bonding a chalcogen or a pnictogen and a magnetic element together. The bond thereof is sufficiently strong and it can be said a stable compound also from calculation of formation energy. In addition, it is also known that many similar compounds (for example, transition metal chalcogenides having various crystal structures such as nickel arsenic type) exist stably.

Furthermore, since a chemical bond between a magnetic ion and a chalcogen or a pnictogen is strong, also a chemical bond between magnetic ions via a chalcogen or a pnictogen is strong. Here, a magnetic coupling is due to magnetic moment among chemical bond and can be said that the stronger the chemical bond is, the stronger also the magnetic coupling is. Accordingly, the half-metallic antiferromagnetic material according to the present invention can be said strong in the magnetic coupling and stable in a magnetic structure.

A half-metallic antiferromagnetic material having a first specific configuration is constituted of two magnetic elements and a chalcogen, the two magnetic elements being any one combination selected from the groups of Cr and Fe, V and Co, Ti and Ni, Cr and Mn, Cr and Ni, Ti and Co, Cr and Co, V and Fe and V and Ni. Since the chalcogen is divalent, according to the combinations, a total number of effective d electrons takes a value from 9 to 12.

A half-metallic antiferromagnetic material having a second specific configuration is constituted of two magnetic elements and a pnictogen, the two magnetic elements being any one combination selected from the groups of Mn and Co, Cr and Ni, V and Mn and Fe and Ni. Since the pnictogen is trivalent, according to the combinations, a total number of effective d electrons takes a value from 6 to 12.

A half-metallic antiferromagnetic material having a third specific configuration is constituted of three magnetic elements and a chalcogen, the three magnetic elements being any one combination selected from the groups of Co and Ti and Cr, V and Fe and Ni, Fe and Mn and V, Cr and Mn and Co, and Mn and V and Co.

A half-metallic antiferromagnetic material where three magnetic elements are any combination of Co and Ti and Cr, V and Fe and Ni, Fe and Mn and V, and Cr and Mn and Co is represented by, for example, a composition formula (AB_{0.5}C_{0.5}) X₂ (A, B and C: magnetic elements, X: chalcogen). In a half-metallic antiferromagnetic material represented by a composition formula (CoTi_{0.5}Cr_{0.5})X₂, since the numbers of effective d electrons of Ti and Cr are 2 and 4, respectively, the number of effective d electrons of Ti_{0.5}Cr_{0.5} is 3, and since the number of effective d electrons of Co is 7, the total number of effective d electrons of Co and Ti and Cr is 10. Similarly, in all of combinations of V and Fe and Ni, Fe and Mn and V, and Cr and Mn and Co, the total number of effective d electrons is 10.

Furthermore, a half-metallic antiferromagnetic material where three magnetic elements are Mn and V and Co is represented by, for example, a composition formula (Mn_{0.5}V_{0.5})(CO_{0.5}Mn_{0.5})X₂ (X: chalcogen). Since the numbers of effective d electrons of Mn, V and Co are 5, 3 and 7, respectively, the number of effective d electrons of Mn_{0.5}V_{0.5} is 4 and the number of effective d electrons of Co_{0.5} and Mn_{0.5} is 6, and the total number of effective d electrons is 10.

A half-metallic antiferromagnetic material having a fourth specific configuration is constituted of three magnetic elements and a pnictogen, the three magnetic elements being Co and Fe and Cr.

The half-metallic antiferromagnetic material having the specific configuration is represented by, for example, a composition formula Co(Fe_{0.5}Cr_{0.5})X₂ (X: pnictogen). Since the numbers of effective d electrons of Fe and Cr are 5 and 3, respectively, the number of effective d electrons of Fe_{0.5}Cr_{0.5} is 4, and since the number of effective d electrons of Co is 6, the total number of effective d electrons is 10.

A half-metallic antiferromagnetic material having a fifth specific configuration is constituted of four magnetic elements and a chalcogen, the four magnetic elements being Ti and Cr and Fe and Ni.

The half-metallic antiferromagnetic material having the specific configuration is represented by, for example, a composition formula (Ti_{0.5}Cr_{0.5}Fe_{0.5}Ni_{0.5})X₂ (X: chalcogen). Since the numbers of effective d electrons of Ti and Cr are 2 and 4, respectively, the number of effective d electrons of Ti_{0.5}Cr_{0.5} is 3. On the other hand, since the numbers of effective d electrons of Fe and Ni are 6 and 8, respectively, the number of effective d electrons of Fe_{0.5}Ni_{0.5} is 7. Accordingly, the total number of effective d electrons of Ti and Cr and Ni and Fe is 10.

### ADVANTAGE OF THE INVENTION

According to the present invention, a half-metallic antiferromagnetic material that exists chemically stably and has a stable magnetic structure can be realized.

### BRIEF DESCRIPTION OF THE DRAWINGS

FIG. 1 is a graph illustrating an electron state density in an antiferromagnetic state of chalcopyrite type (CrFe)Po₂;

FIG. 2 is a graph illustrating an electron state density in an antiferromagnetic state of chalcopyrite type (CrFe)S₂;

FIG. 3 is a graph illustrating an electron state density in an antiferromagnetic state of chalcopyrite type (CrFe)Se₂;

FIG. 4 is a graph illustrating an electron state density in an antiferromagnetic state of chalcopyrite type (CrFe)Te₂;

FIG. 5 is a graph illustrating an electron state density in an antiferromagnetic state of chalcopyrite type (VCo)S₂;

FIG. 6 is a graph illustrating an electron state density in an antiferromagnetic state of chalcopyrite type (VCo)Se₂;

FIG. 7 is a graph illustrating an electron state density in an antiferromagnetic state of rock salt type (CrFe)S₂;

FIG. 8 is a graph illustrating an electron state density in an antiferromagnetic state of rock salt type (VCo)S₂;

FIG. 9 is a graph illustrating an electron state density in an antiferromagnetic state of nickel arsenic type (CrFe)Se₂;

FIG. 10 is a graph illustrating an electron state density in an antiferromagnetic state of wurtzite type (CrFe)S₂;

FIG. 11 is a graph illustrating an electron state density in an antiferromagnetic state of wurtzite type (CrFe)Se₂;

FIG. 12 is a graph illustrating an electron state density in an antiferromagnetic state of zinc blende type (FeCr)S₂;

FIG. 13 is a graph illustrating an electron state density in an antiferromagnetic state of zinc blende type (CrFe)Se₂;

FIG. 14 is a graph illustrating an electron state density in an antiferromagnetic state of zinc blende type (CrFe)Te₂;

FIG. 15 is a graph illustrating an electron state density in an antiferromagnetic state of zinc blende type (MnCr)Te₂;

FIG. 16 is a graph illustrating an electron state density in an antiferromagnetic state of zinc blende type (TiCo)Te₂;

FIG. 17 is a graph illustrating an electron state density in an antiferromagnetic state of zinc blende type (TiNi)Po₂;

FIG. 18 is a graph illustrating an electron state density in an antiferromagnetic state of zinc blende type (TiNi)Se₂ when a lattice constant is set at 11.03;

FIG. 19 is a graph illustrating an electron state density in an antiferromagnetic state of zinc blende type (TiNi)Se₂ when a lattice constant is set at 10.90;

FIG. 20 is a graph illustrating an electron state density in an antiferromagnetic state of zinc blende type (VCo)Po₂;

FIG. 21 is a graph illustrating an electron state density in an antiferromagnetic state of zinc blende type (VCo)S₂;

FIG. 22 is a graph illustrating an electron state density in an antiferromagnetic state of zinc blende type (VCo)Se₂;

FIG. 23 is a graph illustrating an electron state density in an antiferromagnetic state of zinc blende type (VCo)Te₂;

FIG. 24 is a graph illustrating an electron state density in an antiferromagnetic state of nickel arsenic type (MnCo)N₂;

FIG. 25 is a graph illustrating an electron state density in an antiferromagnetic state of zinc blende type (MnCo)N₂;

FIG. 26 is a graph illustrating an electron state density in an antiferromagnetic state of zinc blende type (CrNi)N₂;

FIG. 27 is a graph illustrating an electron state density in an antiferromagnetic state of zinc blende type (FeNi)As₂;

FIG. 28 is a graph illustrating an electron state density in an antiferromagnetic state of wurtzite type (MnCo)N₂;

FIG. 29 is a graph illustrating an electron state density in an antiferromagnetic state of rock salt type (MnCo)N₂;

FIG. 30 is a graph illustrating an electron state density in an antiferromagnetic state of chalcopyrite type (MnCo)N₂;

FIG. 31 is a graph illustrating an electron state density in an antiferromagnetic state of chalcopyrite type (CrNi)N₂;

FIG. 32 is a graph illustrating an electron state density in an antiferromagnetic state of zinc blende type (CrMn_{0.5}Co_{0.5})Se₂;

FIG. 33 is a graph illustrating an electron state density in an antiferromagnetic state of zinc blende type (Ti_{0.5}Cr_{0.5}Fe_{0.5}Ni_{0.5})Se₂;

FIG. 34 is a first table representing results of a first principle electronic state calculation of various intermetallic compounds;

FIG. 35 is a second table representing the foregoing results;

FIG. 36 is a third table representing the foregoing results;

FIG. 37 is a diagram representing an antiferromagnetic domain boundary;

FIG. 38 is a conceptual diagram of a state density curve in a non-magnetic state of a compound represented by a composition formula ABX₂;

FIG. 39 is a conceptual diagram of a state density curve in a ferromagnetic state of the foregoing compounds; and

FIG. 40 is a conceptual diagram of a state density curve in an antiferromagnetic state of the foregoing compounds.

### BEST MODE FOR CARRYING OUT THE INVENTION

In what follows, an embodiment of the present invention will be specifically described along the drawings.

A half-metallic antiferromagnetic material according to the present invention is an intermetallic compound that has a crystal structure of a nickel arsenic type, a zinc blende type, a wurtzite type, a chalcopyrite type or a rock salt type and is constituted of two or more magnetic elements and a chalocogen or a pnictogen. The two or more magnetic elements contain a magnetic element having fewer than 5 effective d electrons and a magnetic element having more than 5 effective d electrons, and a total number of effective d electrons of the two or more magnetic elements is 10 or a value close to 10. Here, the chalcogen is any element of S, Se, Te and Po. On the other hand, the pnictogen is any element of N, As, Sb and Bi.

Specifically, a half-metallic antiferromagnetic material is constituted of two transition metal elements and a chalcogen and represented by a composition formula ABX₂ (A and B: transition metal elements, X: chalcogen). Here, the two transition metal elements are any one combination selected from the groups of Cr and Fe, V and Co, Ti and Ni, Cr and Mn, Cr and Ni, Ti and Co, Cr and Co, V and Fe and V and Ni. Furthermore, a half-metallic antiferromagnetic material can be constituted also of two transition metal elements and a pnictogen and is represented by a composition formula ABX₂ (A and B: transition metal elements, X: pnictogen). Here, the two transition metal elements are any one combination selected from the groups of Mn and Co, Cr and Ni, V and Mn and Fe and Ni.

A half-metallic antiferromagnetic material can be constituted also of three transition metal elements and a chalcogen, the three magnetic elements being any one combination selected from the groups of Co and Ti and Cr, V and Fe and Ni, Fe and Mn and V, Cr and Mn and Co, and Mn and V and Co. Furthermore, a half-metallic antiferromagnetic material can also be constituted of three transition metal elements Co, Fe and Cr and a pnictogen. Still furthermore, a half-metallic antiferromagnetic material can be constituted also of four transition metal elements, Ti and Cr and Ni and Fe and a chalcogen.

The half-metallic antiferromagnetic material according to the present invention can be prepared according to a solid state reaction process. In a preparation step, powderized magnetic elements and chalcogen or pnictogen are thoroughly mixed, followed by encapsulating in a quartz glass tube and by heating at 1000° C. or more, further followed by annealing. Furthermore, a half-metallic antiferromagnetic material having a non-equilibrium crystal structure, for example, zinc blende type (CrFe)S₂, is crystal grown according to molecular beam epitaxy on a substrate.

The half-metallic antiferromagnetic material according to the present invention is not a state where magnetic ions precipitate in a host like a half-metallic antiferromagnetic semiconductor with a semiconductor as a host but a compound obtained by chemically bonding a chalcogen or a pnictogen and a magnetic, element together. The bond thereof is sufficiently strong and it can also be said a stable compound from calculation of formation energy. In addition, it is also known that many similar compounds (for example, transition metal chalcogenides having various crystal structures such as nickel arsenic type) exist stably.

Furthermore, since a chemical bond between a magnetic ion and a chalcogen or a pnictogen is strong, also a chemical bond between magnetic ions via a chalcogen or a pnictogen is strong. Here, a magnetic coupling is due to magnetic moment among chemical bond and can be said that the stronger the chemical bond is, the stronger also the magnetic coupling is. Accordingly, the half-metallic antiferromagnetic material according to the present invention can be said strong in the magnetic coupling and stable in a magnetic structure.

Furthermore, the half-metallic antiferromagnetic material according to the present invention can be readily prepared as mentioned above.

A half-metallic antiferromagnetic material, being a substance of which Fermi surface is 100% spin split, is useful as a spintronic material. Furthermore, a half-metallic antiferromagnetic material does not have a magnetic property and thereby is stable to external perturbation, does not generate magnetic shape anisotropy and thereby is high in likelihood of readily realizing a spin flip by current or spin injection and is expected to apply in a broader field such as a high performance magnetic memory and a magnetic head material.

For example, an application to an MRAM (Magnetic Random Access Memory) can be considered.

In an antiferromagnetic material, a concept corresponding to a magnetic wall is called an antiferromagnetic domain boundary (domain boundary). In an antiferromagnetic material having a magnetic structure such as shown in FIG. 37, a position where the order of spin-up and spin-down is replaced is an antiferromagnetic domain boundary. In the figure, when a current is flowed from a left side, electrons are scattered at the domain boundary; accordingly, electric resistance becomes larger. Particularly in a half-metallic antiferromagnetic material, because of a property of being a half metal, on a left side and a right side of the boundary, a direction of metallic electron spins is varied; accordingly, in principle, when a boundary exists, an electric current does not flow. On the other hand, electrons are scattered in the boundary; accordingly, a momentum variation is generated in an electron system. However, an impulse owing to the momentum variation is a force that the boundary itself receives from an electric current; accordingly, the boundary shifts. The boundary shift phenomenon can be used to prepare an MRAM.

### First Example

A half-metallic antiferromagnetic material of the present Example is an intermetallic compound having a chalcopyrite type crystal structure and represented by a composition formula (CrFe)Po₂.

In order to confirm that the intermetallic compound of the present Example has a half-metallic antiferromagnetic property, the present inventors conducted a first principle electronic state calculation. Here, as a method of the first principle electronic state calculation, a known KKR-CPA-LDA method obtained by combining a KKR (Korringa-kohn-Rostoker) method (also called a Green function method), a CPA (Coherent-Potential Approximation) method and an LDA (Local-Density Approximation) method was adopted (Monthly publication “Kagaku Kogyo, Vol. 53, No. 4 (2002)” pp. 20-24, and “Shisutemu/Seigyo/Joho, Vol. 48, No. 7” pp. 256-260).

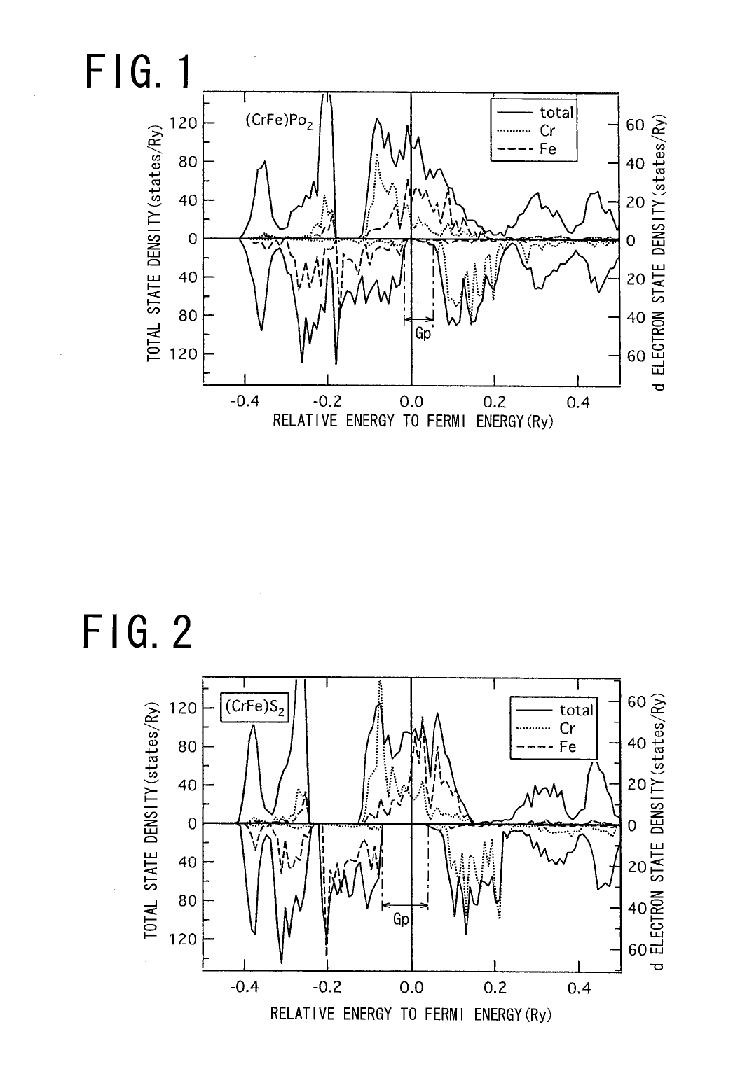

FIG. 1 represents a state density curve in an antiferromagnetic state obtained by conducting the first principle electronic state calculation of chalcopyrite type (CrFe)Po₂. In the figure, a solid line represents a total state density, a dotted line represents a local state density at a 3d orbital position of Cr, and a broken line represents a local state density at a 3d orbital position of Fe.

As shown with a solid line in the figure, a state density of spin-down electrons is zero to form a band gap Gp and a Fermi energy exists in the band gap. On the other hand, a state density of spin-up electrons is larger than zero in the vicinity of the Fermi energy. Thus, while a state of spin-down electrons exhibits a property as a semiconductor, a state of spin-up electrons exhibits a property as a metal, that is, it can be said that a half-metallic property is developed.

Furthermore, since Po that is a chalcogen is divalent, the numbers of effective d electrons of Cr and Fe are 4 and 6, respectively, and thereby a total number of effective d electrons is 10. When a total state density of spin-up electrons and a total state density of spin-down electrons were each integrated up to the Fermi energy, both integral values were the same; accordingly, it can be said that magnetic moments of Fe and Cr cancel out each other and thereby magnetization is zero as a whole.

From the results mentioned above, it can be said that the intermetallic compound of the present Example has a half-metallic antiferromagnetic property.

### Second Example

A half-metallic antiferromagnetic material of the present Example is an intermetallic compound having a chalcopyrite type crystal structure and represented by a composition formula (CrFe)S₂.

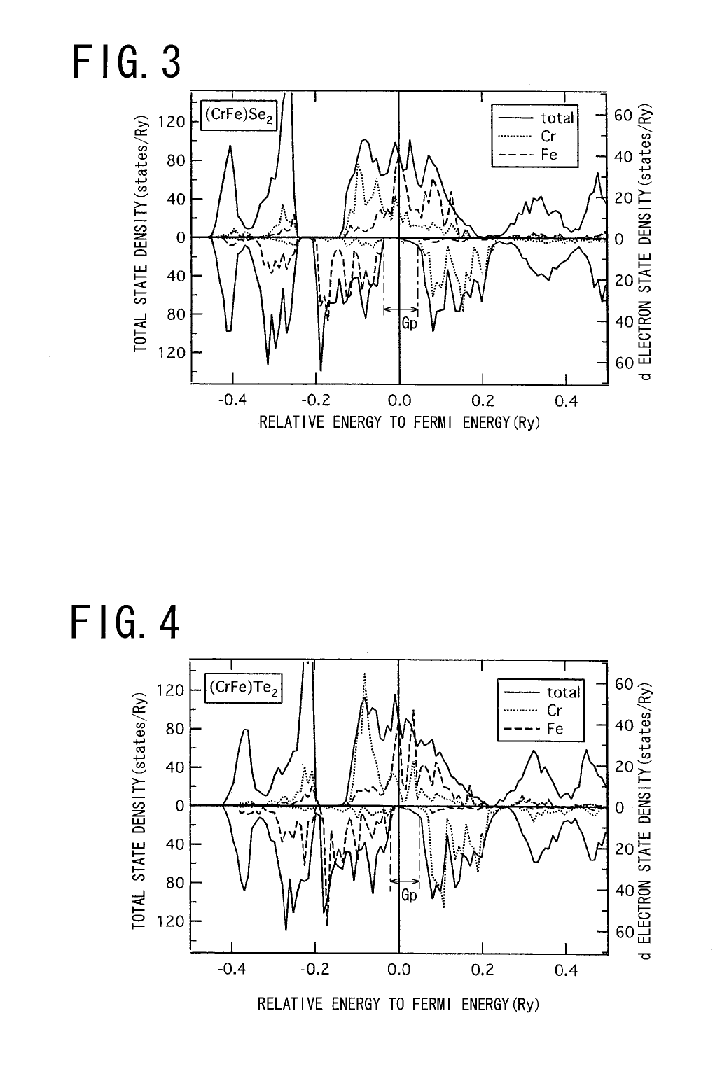

FIG. 2 represents a state density curve in an antiferromagnetic state obtained by conducting the first principle electronic state calculation of chalcopyrite type (CrFe)S₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Third Example

A half-metallic antiferromagnetic material of the present Example is an intermetallic compound having a chalcopyrite type crystal structure and represented by a composition formula (CrFe)Se₂.

FIG. 3 represents a state density curve in an antiferromagnetic state obtained by conducting the first principle electronic state calculation of chalcopyrite type (CrFe)Se₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Fourth Example

A half-metallic antiferromagnetic material of the present Example is an intermetallic compound having a chalcopyrite type crystal structure and represented by a composition formula (CrFe)Te₂.

FIG. 4 represents a state density curve in an antiferromagnetic state obtained by conducting the first principle electronic state calculation of chalcopyrite type (CrFe)Te₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Fifth Example

A half-metallic antiferromagnetic material of the present Example is an intermetallic compound having a chalcopyrite type crystal structure and represented by a composition formula (VCo)S₂.

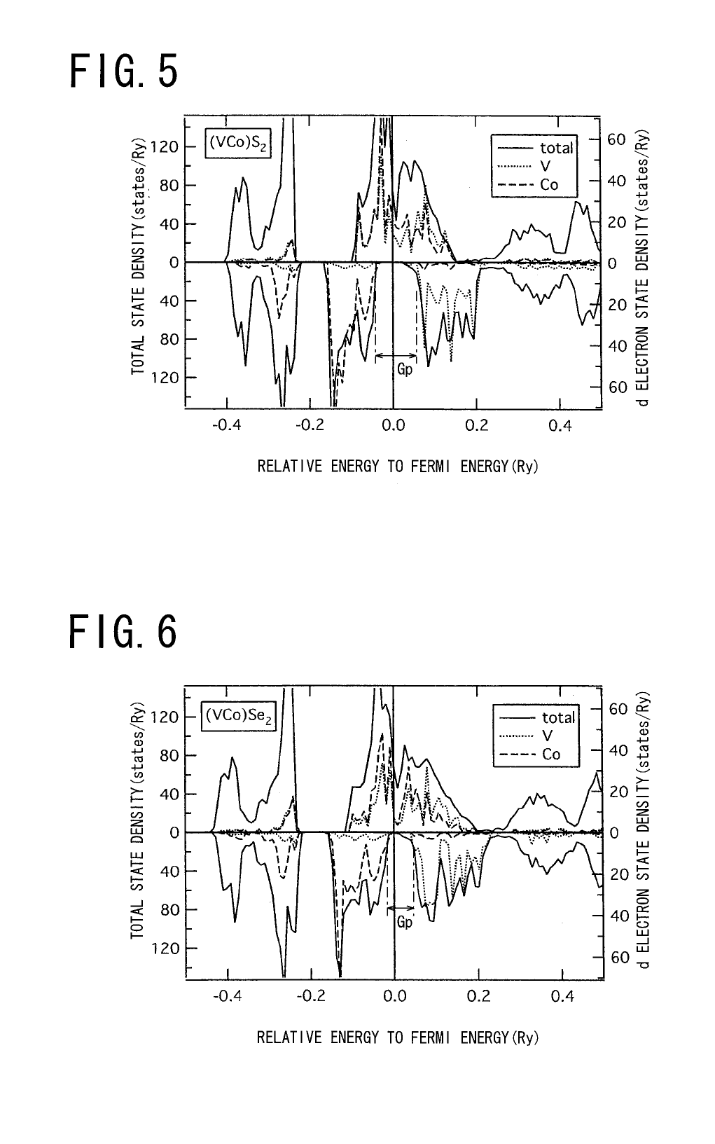

FIG. 5 represents a state density curve in an antiferromagnetic state obtained by conducting the first principle electronic state calculation of chalcopyrite type (VCo)S₂. In the figure, a solid line represents a total state density, a dotted line represents a local state density at a 3d orbital position of V, and a broken line represents a local state density at a 3d orbital position of Co.

From a state density curve shown with a solid line in the figure, it can be said that a half-metallic property is developed. Furthermore, since S that is chalcogen is divalent, the numbers of effective d electrons of V and Co are 3 and 7, respectively, a total number of effective d electrons is 10. When a total state density of spin-up electrons and a total state density of spin-down electrons were each integrated up to the Fermi energy, both integral values were the same; accordingly, it can be said that magnetic moments of Co and V cancel out each other and thereby magnetization as a whole is zero.

From the result mentioned above, it can be said that the intermetallic compound of the present Example has a half-metallic antiferromagnetic property.

### Sixth Example

A half-metallic antiferromagnetic material of the present Example is an intermetallic compound having a chalcopyrite type crystal structure and represented by a composition formula (VCo)Se₂.

FIG. 6 represents a state density curve in an antiferromagnetic state obtained by conducting the first principle electronic state calculation of chalcopyrite type (VCo)Se₂. In the figure, a solid line represents a total state density, a dotted line represents a local state density at a 3d orbital position of V, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Seventh Example

A half-metallic antiferromagnetic material of the present Example is an intermetallic compound having a rock salt type crystal structure and represented by a composition formula (CrFe)S₂.

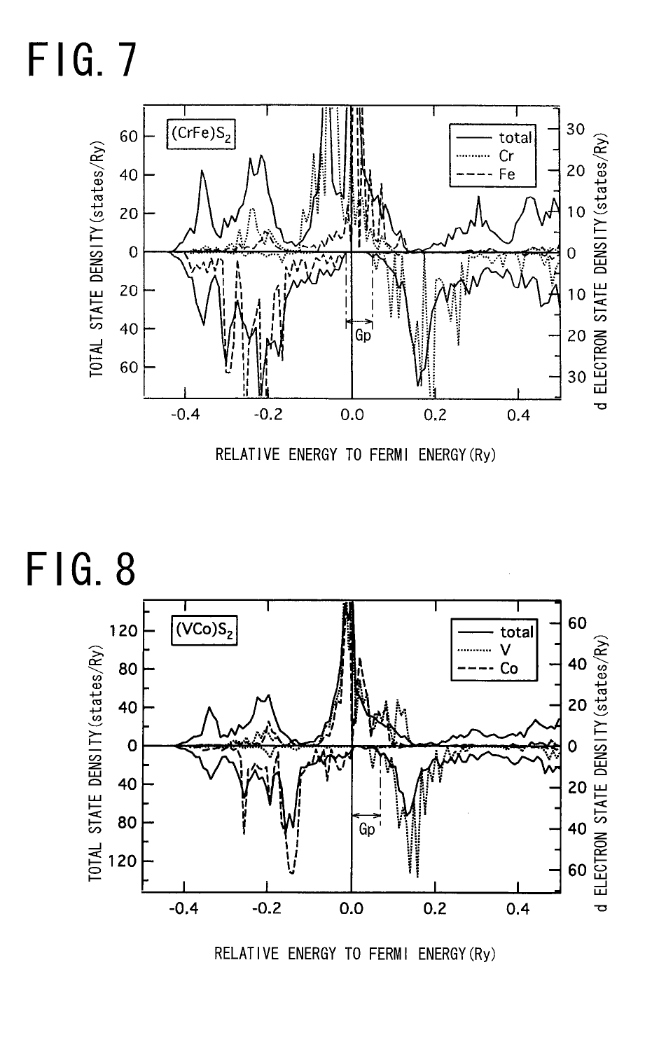

FIG. 7 represents a state density curve in an antiferromagnetic state obtained by conducting the first principle electronic state calculation of rock salt type (CrFe)S₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Eighth Example

A half-metallic antiferromagnetic material of the present Example is an intermetallic compound having a rock salt type crystal structure and represented by a composition formula (VCo)S₂.

FIG. 8 represents a state density curve in an antiferromagnetic state obtained by conducting the first principle electronic state calculation of rock salt type (VCo)S₂. In the figure, a solid line represents a total state density, a dotted line represents a local state density at a 3d orbital position of V, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Ninth Example

A half-metallic antiferromagnetic material of the present Example is an intermetallic compound having a nickel arsenic type crystal structure and represented by a composition formula (CrFe)Se₂.

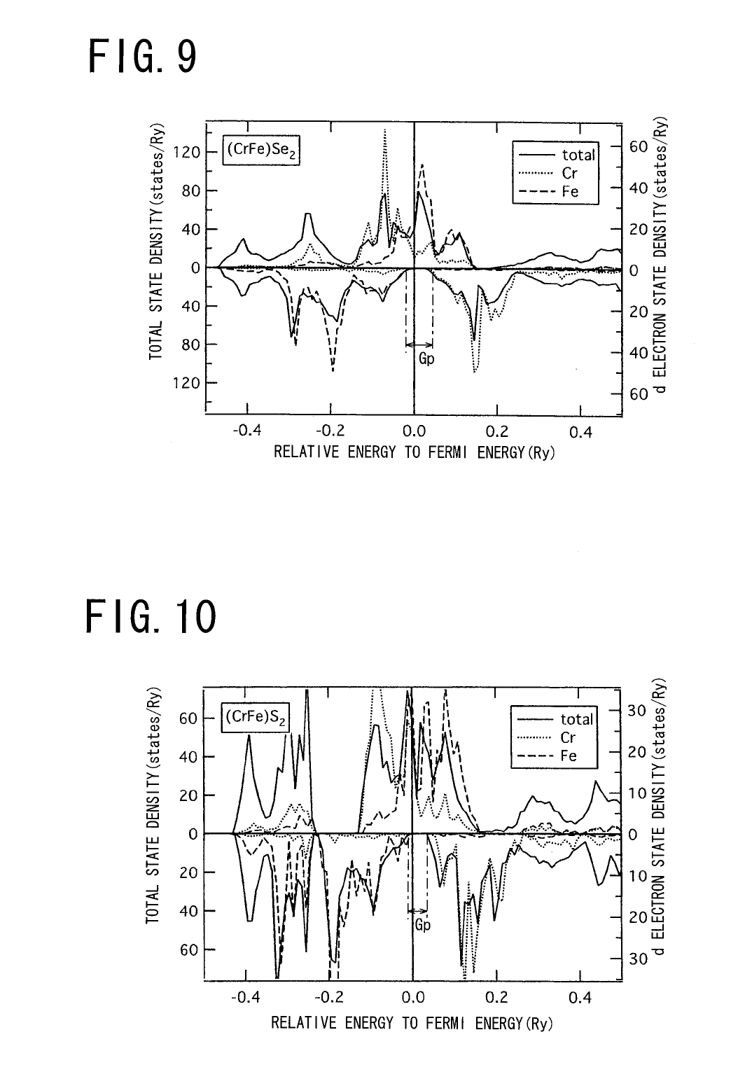

FIG. 9 represents a state density curve in an antiferromagnetic state obtained by conducting the first principle electronic state calculation of nickel arsenic type (CrFe)Se₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

Furthermore, a magnetic transition temperature (Neel temperature) where an antiferromagnetic state transitions to a paramagnetic state was calculated and found to be 1094K. Here, the Neel temperature was calculated according to a known method that uses Cluster approximation (J. Phys.: Condens. Matter 19 (2007) 365233).

### Tenth Example

A half-metallic antiferromagnetic material of the present Example is an intermetallic compound having a wurtzite type crystal structure and represented by a composition formula (CrFe)S₂.

FIG. 10 represents a state density curve in an antiferromagnetic state obtained by conducting the first principle electronic state calculation of wurtzite type (CrFe)S₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Eleventh Example

A half-metallic antiferromagnetic material of the present Example is an intermetallic compound having a wurtzite type crystal structure and represented by a composition formula (CrFe)Se₂.

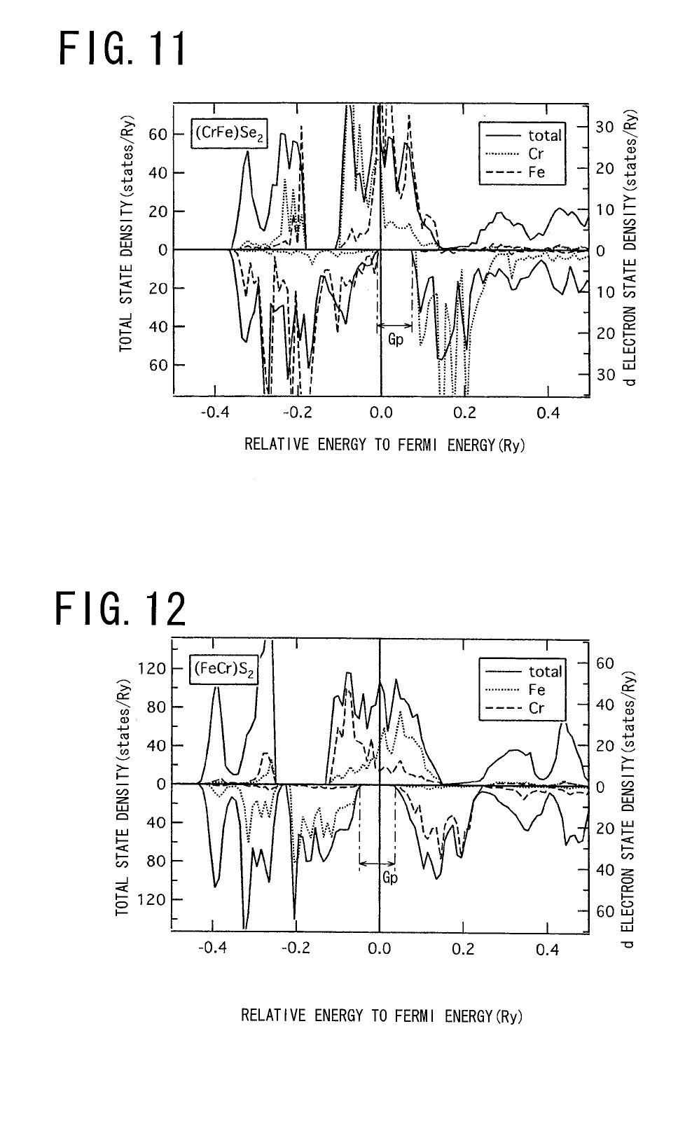

FIG. 11 represents a state density curve in an antiferromagnetic state obtained by conducting the first principle electronic state calculation of wurtzite type (CrFe)Se₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Twelfth Example

A half-metallic antiferromagnetic material of the present Example is an intermetallic compound having a zinc blende type crystal structure and represented by a composition formula (FeCr)S₂.

FIG. 12 represents a state density curve in an antiferromagnetic state obtained by conducting the first principle electronic state calculation of zinc blende type (FeCr)S₂. In the figure, a solid line represents a total state density, a dotted line represents a local state density at a 3d orbital position of Fe, and a broken line represents a local state density at a 3d orbital position of Cr. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property. Furthermore, the Neel temperature was calculated and found to be 1016K.

### Thirteenth Example

A half-metallic antiferromagnetic material of the present Example is an intermetallic compound having a zinc blende type crystal structure and represented by a composition formula (CrFe)Se₂.

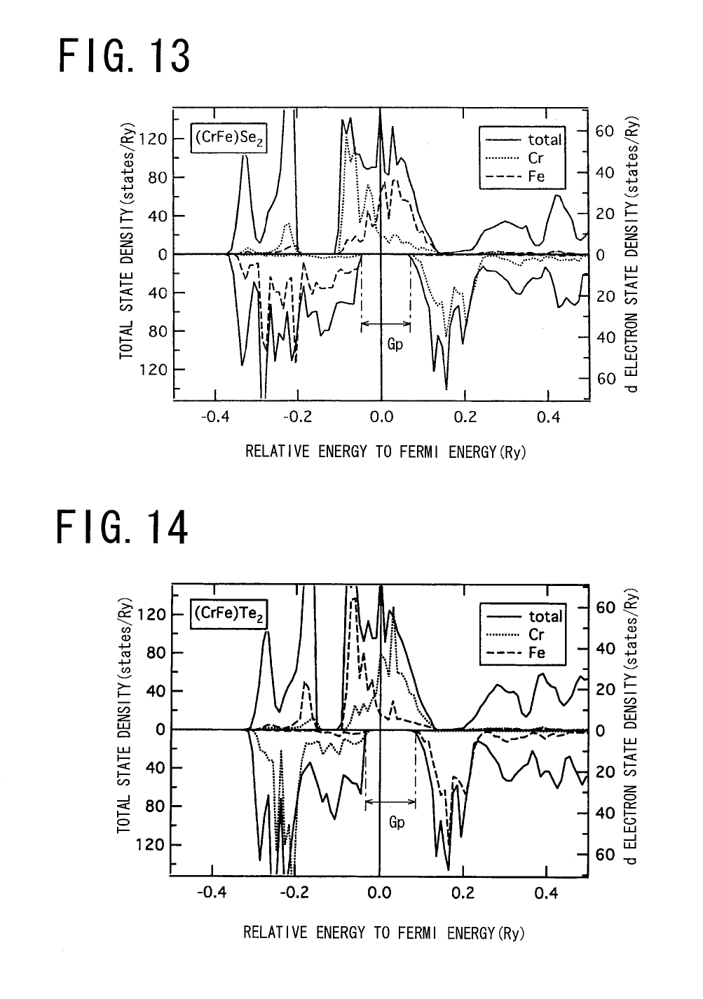

FIG. 13 represents a state density curve in an antiferromagnetic state obtained by conducting the first principle electronic state calculation of zinc blende type (CrFe)Se₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property. Furthermore, the Neel temperature was calculated and found to be 926K.

### Fourteenth Example

A half-metallic antiferromagnetic material of the present Example is an intermetallic compound having a zinc blende type crystal structure and represented by a composition formula (CrFe)Te₂.

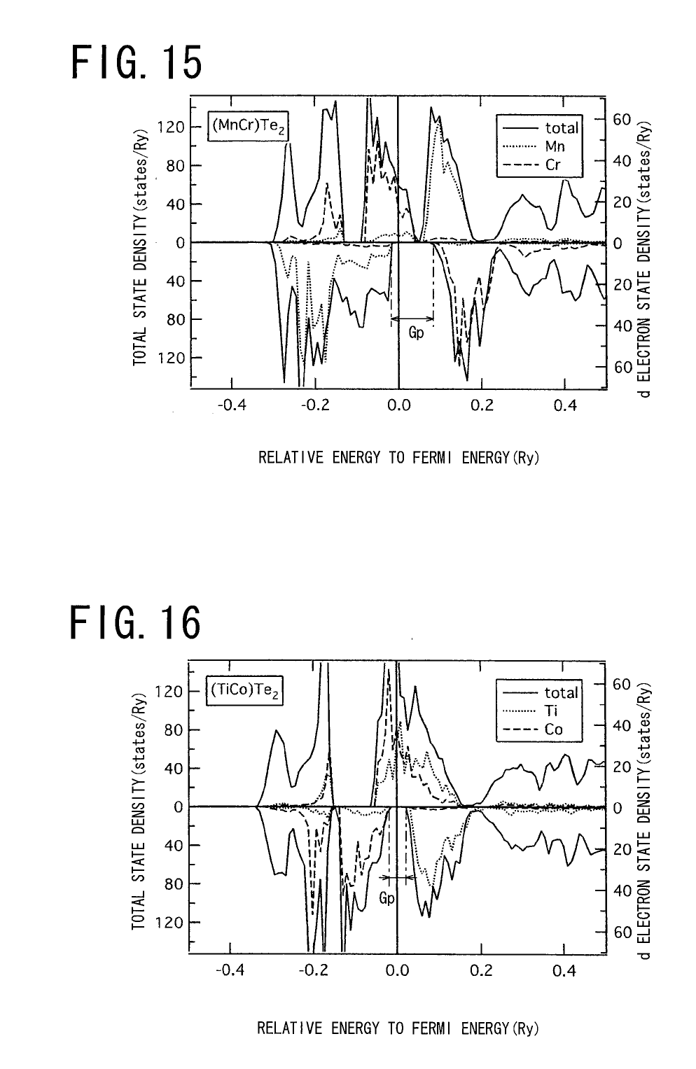

FIG. 14 represents a state density curve in an antiferromagnetic state obtained by conducting the first principle electronic state calculation of zinc blende type (CrFe)Te₂. In the figure, a solid line represents a total state density, a dotted line represents a local state density at a 3d orbital position of Cr, and a broken line represents a local state density at a 3d orbital position of Fe. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property. Furthermore, the Neel temperature was calculated and found to be 640K.

### Fifteenth Example

A half-metallic antiferromagnetic material of the present Example is an intermetallic compound having a zinc blende type crystal structure and represented by a composition formula (MnCr)Te₂.

FIG. 15 represents a state density curve in an antiferromagnetic state obtained by conducting the first principle electronic state calculation of zinc blende type (MnCr)Te₂. In the figure, a solid line represents a total state density, a dotted line represents a local state density at a 3d orbital position of Mn, and a broken line represents a local state density at a 3d orbital position of Cr.

From a state density curve shown with a solid line in the figure, it can be said that a half-metallic property is developed. Furthermore, since Te that is a chalcogen is divalent, the numbers of effective d electrons of Mn and Cr are 5 and 4, respectively, and the total number of effective d electrons is 9. When a total state density of spin-up electrons and a total state density of spin-down electrons were each integrated up to the Fermi energy, both integral values were slightly different; accordingly, it can be said that slight magnetization remains.

From the result mentioned above, it can be said that the intermetallic compound of the present Example has a half-metallic ferrimagnetic property. In addition, when concentrations of Mn and Cr are controlled, an intermetallic compound having an antiferromagnetic property can be obtained.

### Sixteenth Example

A half-metallic antiferromagnetic material of the present Example is an intermetallic compound having a zinc blende type crystal structure and represented by a composition formula (TiCo)Te₂.

FIG. 16 represents a state density curve in an antiferromagnetic state obtained by conducting the first principle electronic state calculation of zinc blende type (TiCo)Te₂. In the figure, a solid line represents a total state density, a dotted line represents a local state density at a 3d orbital position of Ti, and a broken line represents a local state density at a 3d orbital position of Co.

From a state density curve shown with a solid line in the figure, it can be said that a half-metallic property is developed. Furthermore, since Te that is a chalcogen is divalent, the numbers of effective d electrons of Ti and Co are 2 and 7, respectively, and the total number of effective d electrons is 9. When a total state density of spin-up electrons and a total state density of spin-down electrons were each integrated up to the Fermi energy, both integral values were slightly different; accordingly, it can be said that slight magnetization remains.

From the result mentioned above, it can be said that the intermetallic compound of the present Example has a half-metallic ferrimagnetic property. In addition, when concentrations of Ti and Co are controlled, an intermetallic compound having an antiferromagnetic property can be obtained.

### Seventeenth Example

A half-metallic antiferromagnetic material of the present Example is an intermetallic compound having a zinc blende type crystal structure and represented by a composition formula (TiNi)Po₂.

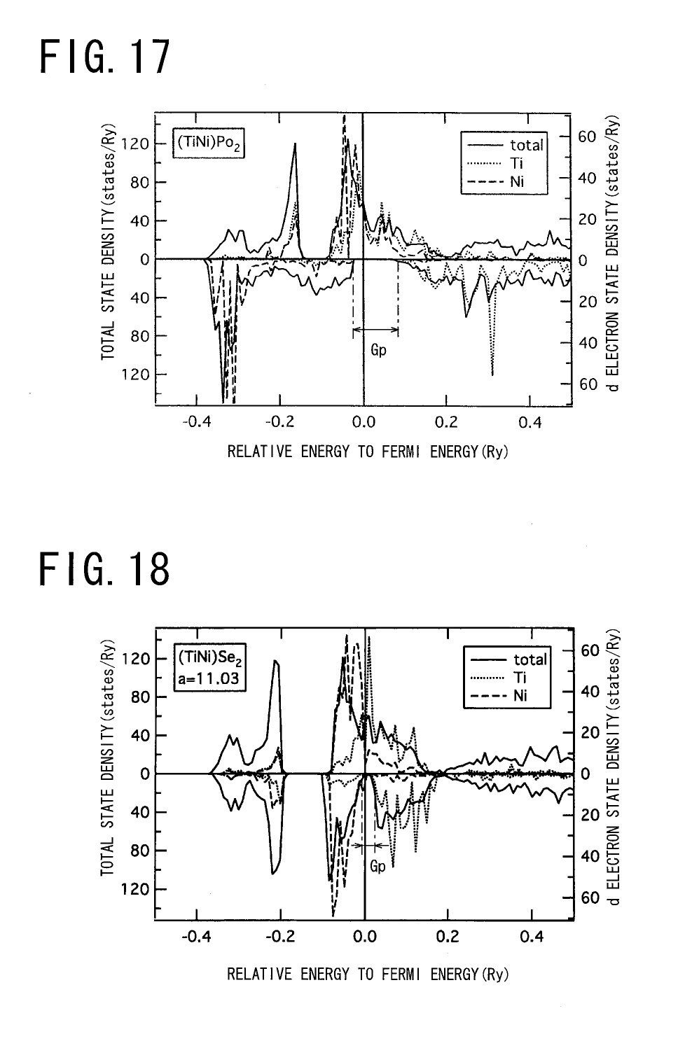

FIG. 17 represents a state density curve in an antiferromagnetic state obtained by conducting the first principle electronic state calculation of zinc blende type (TiNi)Po₂. In the figure, a solid line represents a total state density, a dotted line represents a local state density at a 3d orbital position of Ti, and a broken line represents a local state density at a 3d orbital position of Ni. As a method of the first principle electronic state calculation, in place of the KKR-CPA-LDA method, a known method called a LDA+U method where a correction is applied to an interelectronic interaction was adopted.

From a state density curve shown with a solid line in the figure, it can be said that a half-metallic property is developed. Furthermore, since Po that is a chalcogen is divalent, the numbers of effective d electrons of Ti and Ni are 2 and 8, respectively, and the total number of effective d electrons is 10. When a total state density of spin-up electrons and a total state density of spin-down electrons were each integrated up to the Fermi energy, both integral values were the same; accordingly, it can be said that magnetic moments of Ni and Ti cancel out each other and thereby magnetization as a whole is zero.

From the result mentioned above, it can be said that the intermetallic compound of the present Example has a half-metallic antiferromagnetic property.

### Eighteenth Example

A half-metallic antiferromagnetic material of the present Example is an intermetallic compound having a zinc blende type crystal structure and represented by a composition formula (TiNi)Se₂.

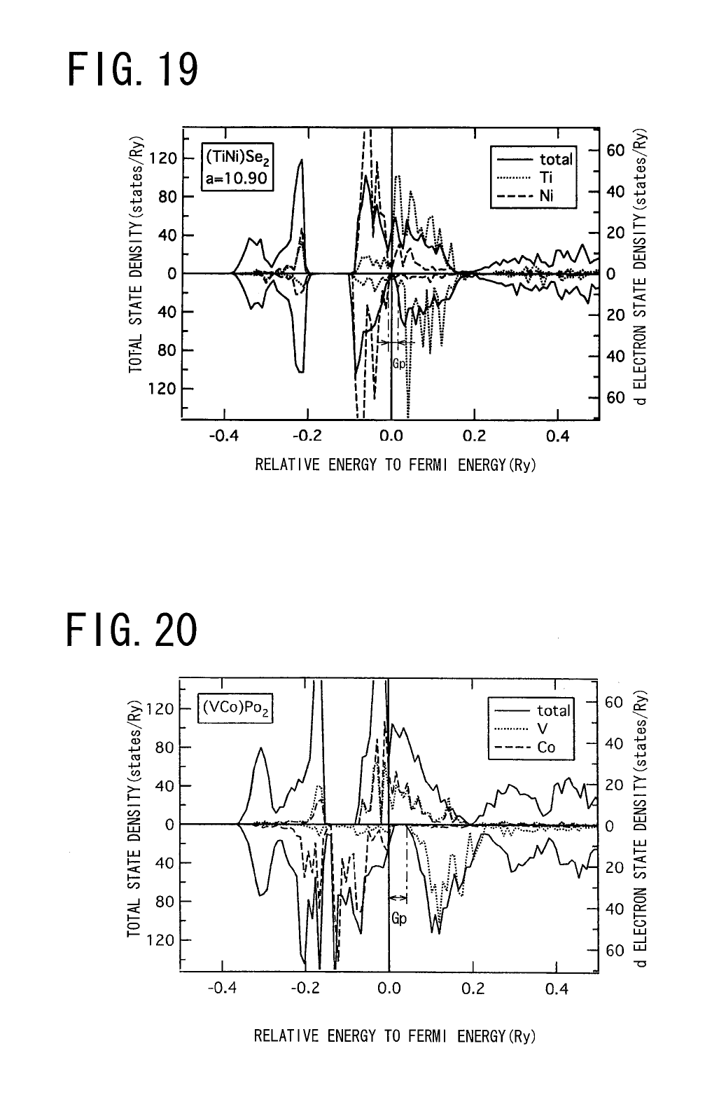

FIGS. 18 and 19 each represent a state density curve in an antiferromagnetic state obtained by conducting the first principle electronic state calculation of zinc blende type (TiNi)Se₂, and in FIG. 18 a lattice constant a was set at 11.03 and in FIG. 19 a lattice constant a was set at 10.90. In each figure, a solid line represents a total state density, a dotted line represents a local state density at a 3d orbital position of Ti, and a broken line represents a local state density at a 3d orbital position of Ni. Even when the lattice constant a is set at any of values, from a state density curve shown with a solid line in each figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Nineteenth Example

A half-metallic antiferromagnetic material of the present Example is an intermetallic compound having a zinc blende type crystal structure and represented by a composition formula (VCo)Po₂.

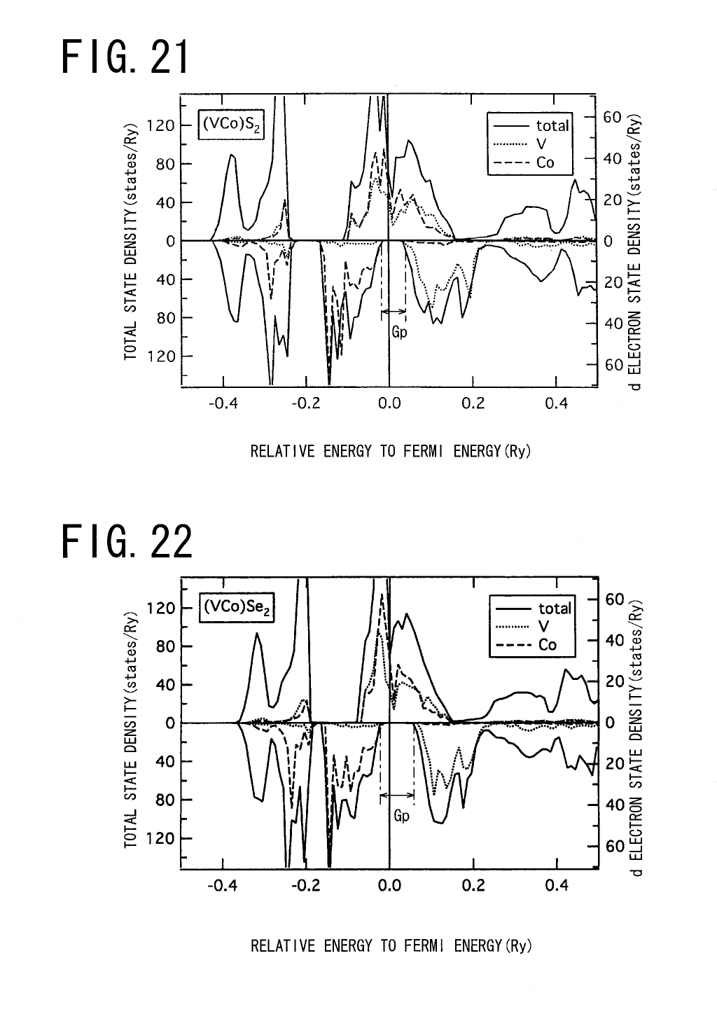

FIG. 20 represents a state density curve in an antiferromagnetic state obtained by conducting the first principle electronic state calculation of zinc blende type (VCo)Po₂. In the figure, a solid line represents a total state density, a dotted line represents a local state density at a 3d orbital position of V, and a broken line represents a local state density at a 3d orbital position of Co. As a method of the first principle electronic state calculation, in place of the KKR-CPA-LDA method, a LDA+U method was adopted. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Twentieth Example

A half-metallic antiferromagnetic material of the present Example is an intermetallic compound having a zinc blende type crystal structure and represented by a composition formula (VCo)S₂.

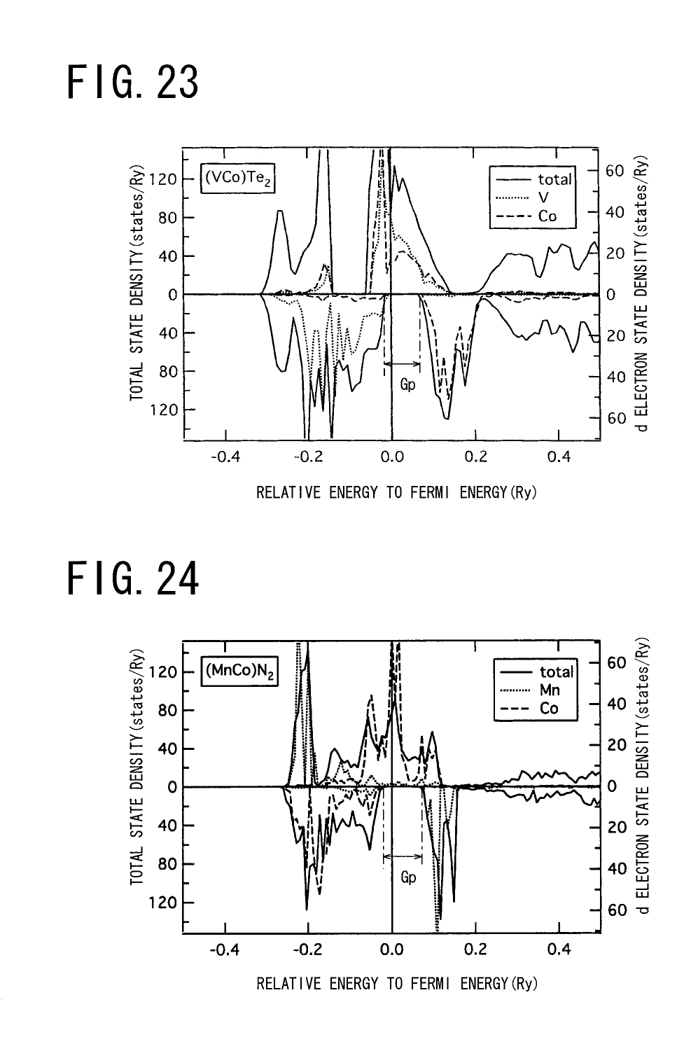

FIG. 21 represents a state density curve in an antiferromagnetic state obtained by conducting the first principle electronic state calculation of zinc blende type (VCo)S₂. In the figure, a solid line represents a total state density, a dotted line represents a local state density at a 3d orbital position of V, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property. Furthermore, the Neel temperature was calculated and found to be 1025K.

### Twenty-First Example

A half-metallic antiferromagnetic material of the present Example is an intermetallic compound having a zinc blende type crystal structure and represented by a composition formula (VCo)Se₂.

FIG. 22 represents a state density curve in an antiferromagnetic state obtained by conducting the first principle electronic state calculation of zinc blende type (VCo)Se₂. In the figure, a solid line represents a total state density, a dotted line represents a local state density at a 3d orbital position of V, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property. Furthermore, the Neel temperature was calculated and found to be 880K.

### Twenty-Second Example

A half-metallic antiferromagnetic material of the present Example is an intermetallic compound having a zinc blende type crystal structure and represented by a composition formula (VCo)Te₂.

FIG. 23 represents a state density curve in an antiferromagnetic state obtained by conducting the first principle electronic state calculation of zinc blende type (VCo)Te₂. In the figure, a solid line represents a total state density, a dotted line represents a local state density at a 3d orbital position of V, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property. Furthermore, the Neel temperature was calculated and found to be 759K.

### Twenty-Third Example

A half-metallic antiferromagnetic material of the present Example is an intermetallic compound having a nickel arsenic type crystal structure and represented by a composition formula (MnCo)N₂.

FIG. 24 represents a state density curve in an antiferromagnetic state obtained by conducting the first principle electronic state calculation of nickel arsenic type (MnCo)N₂. In the figure, a solid line represents a total state density, a dotted line represents a local state density at a 3d orbital position of Mn, and a broken line represents a local state density at a 3d orbital position of Co.

From a state density curve shown with a solid line in the figure, it can be said that a half-metallic property is developed. Furthermore, since N that is a pnictogen is trivalent, the numbers of effective d electrons of Mn and Co are 4 and 6, respectively, and the total number of effective d electrons is 10. When a total state density of spin-up electrons and a total state density of spin-down electrons were each integrated up to the Fermi energy, both integral values were the same; accordingly, it can be said that magnetic moments of Co and Mn cancel out each other and thereby magnetization as a whole is zero.

From the result mentioned above, it can be said that the intermetallic compound of the present Example has a half-metallic antiferromagnetic property.

### Twenty-Fourth Example

A half-metallic antiferromagnetic material of the present Example is an intermetallic compound having a zinc blende type crystal structure and represented by a composition formula (MnCo)N₂.

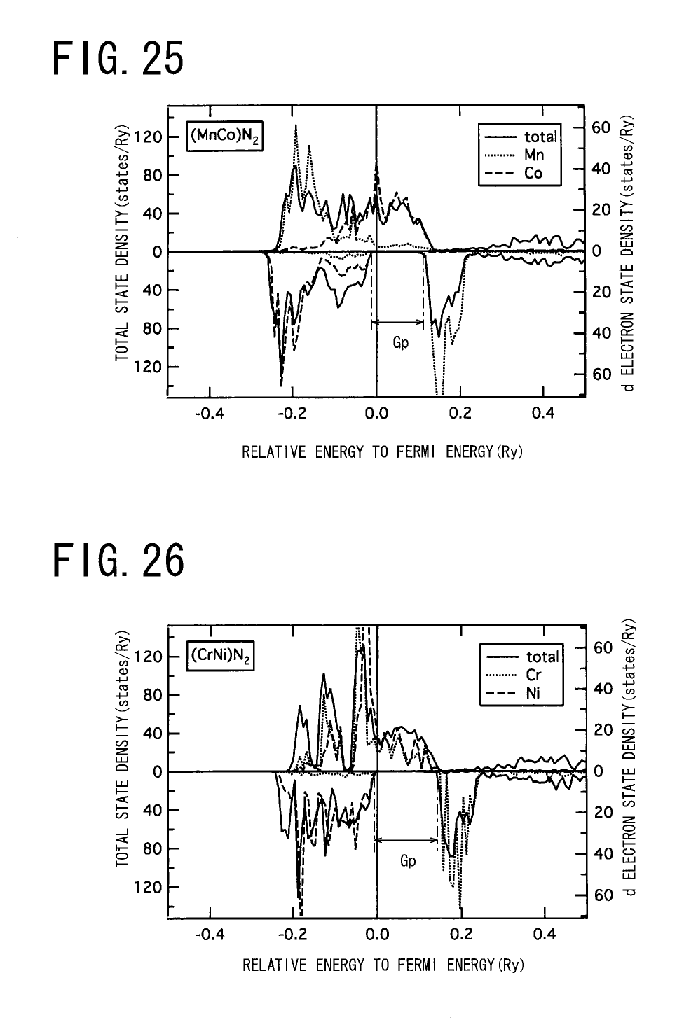

FIG. 25 represents a state density curve in an antiferromagnetic state obtained by conducting the first principle electronic state calculation of zinc blende type (MnCo)N₂. In the figure, a solid line represents a total state density, a dotted line represents a local state density at a 3d orbital position of Mn, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Twenty-Fifth Example

A half-metallic antiferromagnetic material of the present Example is an intermetallic compound having a zinc blende type crystal structure and represented by a composition formula (CrNi)N₂.

FIG. 26 represents a state density curve in an antiferromagnetic state obtained by conducting the first principle electronic state calculation of zinc blende type (CrNi)N₂. In the figure, a solid line represents a total state density, a dotted line represents a local state density at a 3d orbital position of Cr, and a broken line represents a local state density at a 3d orbital position of Ni.

From a state density curve shown with a solid line in the figure, it can be said that a half-metallic property is developed. Furthermore, since N is trivalent, the numbers of effective d electrons of Cr and Ni are 3 and 7, respectively, and the total number of effective d electrons is 10. When a total state density of spin-up electrons and a total state density of spin-down electrons were each integrated up to the Fermi energy, both integral values were the same; accordingly, it can be said that magnetic moments of Ni and Cr cancel out each other and thereby magnetization as a whole is zero.

From the result mentioned above, it can be said that the intermetallic compound of the present Example has a half-metallic antiferromagnetic property.

### Twenty-Sixth Example

A half-metallic antiferromagnetic material of the present Example is an intermetallic compound having a zinc blende type crystal structure and represented by a composition formula (FeNi)As₂.

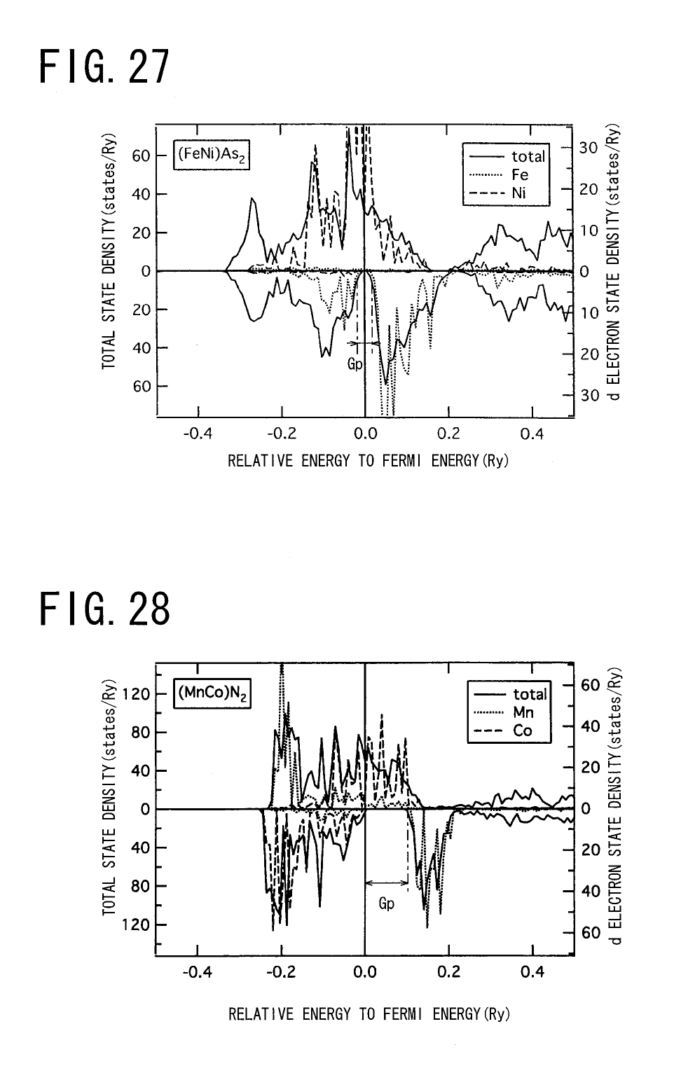

FIG. 27 represents a state density curve in an antiferromagnetic state obtained by conducting the first principle electronic state calculation of zinc blende type (FeNi)As₂. In the figure, a solid line represents a total state density, a dotted line represents a local state density at a 3d orbital position of Fe, and a broken line represents a local state density at a 3d orbital position of Ni. As a method of the first principle electronic state calculation, in place of the KKR-CPA-LDA method, a LDA+U method was adopted.

From a state density curve shown with a solid line in the figure, it can be said that a half-metallic property is developed. Furthermore, since As that is a pnictogen is trivalent, the numbers of effective d electrons of Fe and Ni are 5 and 7, respectively, and the total number of effective d electrons is 12. When a total state density of spin-up electrons and a total state density of spin-down electrons were each integrated up to the Fermi energy, both integral values were slightly different; accordingly, it can be said that slight magnetization remains.

From the result mentioned above, it can be said that the intermetallic compound of the present Example has a half-metallic ferrimagnetic property.

### Twenty-Seventh Example

A half-metallic antiferromagnetic material of the present Example is an intermetallic compound having a wurtzite type crystal structure and represented by a composition formula (MnCo)N₂.

FIG. 28 represents a state density curve in an antiferromagnetic state obtained by conducting the first principle electronic state calculation of wurtzite type (MnCo)N₂. In the figure, a solid line represents a total state density, a dotted line represents a local state density at a 3d orbital position of Mn, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Twenty-Eighth Example

A half-metallic antiferromagnetic material of the present Example is an intermetallic compound having a rock salt type crystal structure and represented by a composition formula (MnCo)N₂.

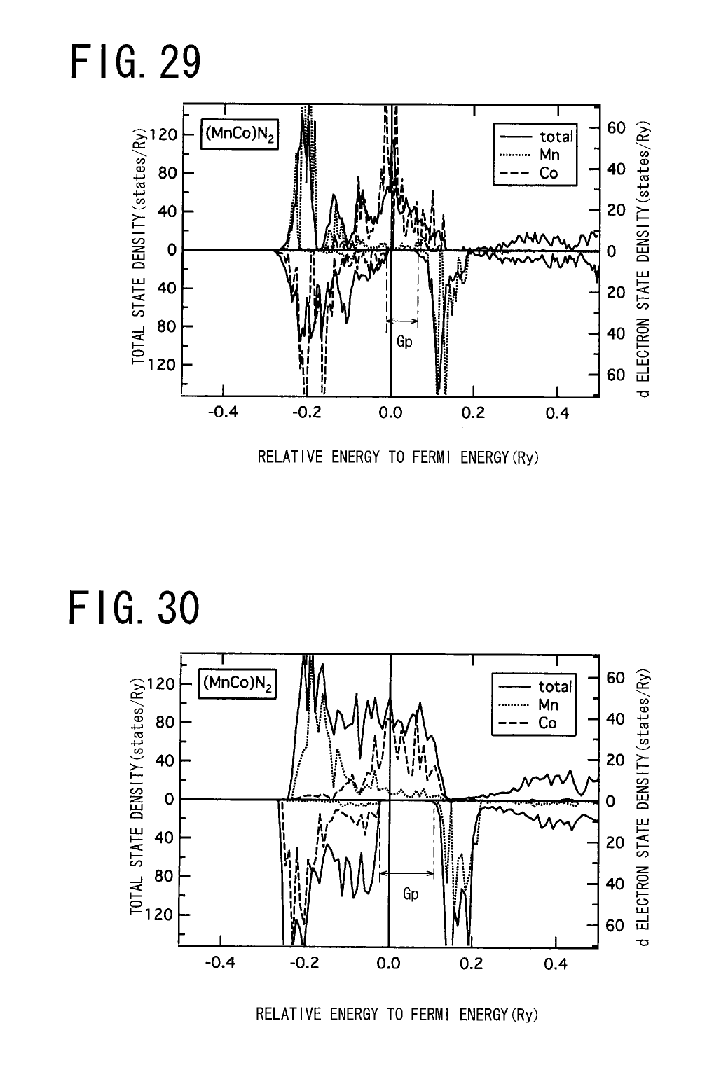

FIG. 29 represents a state density curve in an antiferromagnetic state obtained by conducting the first principle electronic state calculation of rock salt type (MnCo)N₂. In the figure, a solid line represents a total state density, a dotted line represents a local state density at 3d orbital position of Mn, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Twenty-Ninth Example

A half-metallic antiferromagnetic material of the present Example is an intermetallic compound having a chalcopyrite type crystal structure and represented by a composition formula (MnCo)N₂.

FIG. 30 represents a state density curve in an antiferromagnetic state obtained by conducting the first principle electronic state calculation of chalcopyrite type (MnCo)N₂. In the figure, a solid line represents a total state density, a dotted line represents a local state density at a 3d orbital position of Mn, and a broken line represents a local state density at a 3d orbital position of Co. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Thirtieth Example

A half-metallic antiferromagnetic material of the present Example is an intermetallic compound having a chalcopyrite type crystal structure and represented by a composition formula (CrNi)N₂.

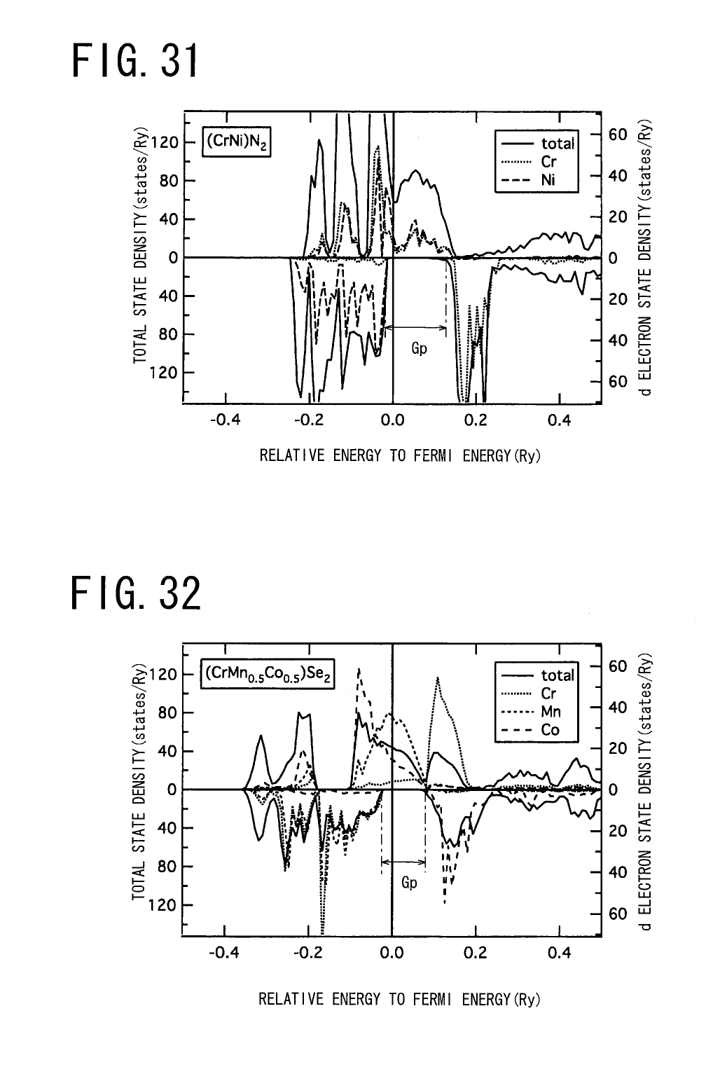

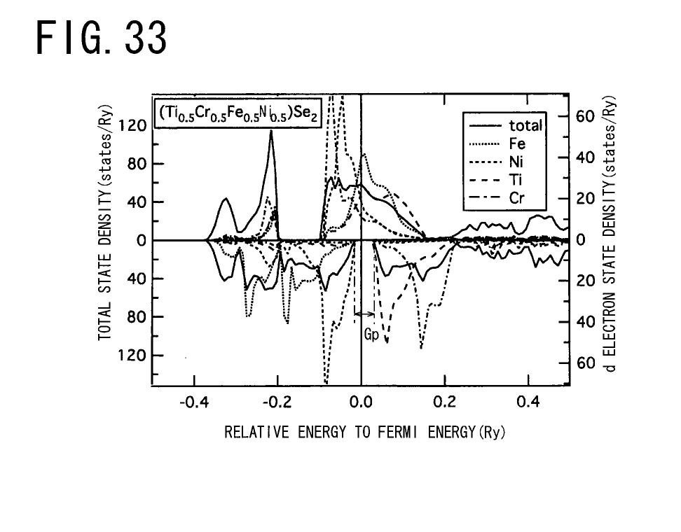

FIG. 31 represents a state density curve in an antiferromagnetic state obtained by conducting the first principle electronic state calculation of chalcopyrite type (CrNi)N₂. In the figure, a solid line represents a total state density, a dotted line represents a local state density at a 3d orbital position of Cr, and a broken line represents a local state density at a 3d orbital position of Ni. From a state density curve shown with a solid line in the figure, it can be said that a half-metallic property is developed. Furthermore, when a total state density of spin-up electrons and a total state density of spin-down electrons were each integrated up to the Fermi energy, both integral values were the same; accordingly, it can be said that magnetization as a whole is zero. Accordingly, it can be said that the intermetallic compound of the present Example has a half-metallic antiferromagnetic property.

### Thirty-First Example

A half-metallic antiferromagnetic material of the present Example is an intermetallic compound having a zinc blende type crystal structure and represented by a composition formula (CrMn_{0.5}Co_{0.5})Se₂.

FIG. 32 represents a state density curve in an antiferromagnetic state obtained by conducting the first principle electronic state calculation of zinc blende type (CrMn_{0.5}Co_{0.5})Se₂. In the figure, a solid line represents a total state density, a dotted line and two broken lines represent local state densities at a 3d orbital position of Cr, Mn and Co, respectively.

From a state density curve shown with a solid line in the figure, it can be said that a half-metallic property is developed. Furthermore, since Se that is a chalcogen is divalent, the numbers of effective d electrons of Mn and Co are 5 and 7, respectively, and the number of effective d electrons of Mn_{0.5}Co_{0.5} is 6. Furthermore, since the number of effective d electrons of Cr is 4, the total number of effective d electrons is 10. When a total state density of spin-up electrons and a total state density of spin-down electrons were each integrated up to the Fermi energy, both integral values were the same; accordingly, it can be said that magnetic moments of Cr and Mn and Co cancel out each other and thereby magnetization as a whole is zero.

From the result mentioned above, it can be said that the intermetallic compound of the present Example has a half-metallic antiferromagnetic property.

### Thirty-Second Example

A half-metallic antiferromagnetic material of the present Example is an intermetallic compound having a zinc blende type crystal structure and represented by a composition formula (Ti_{0.5}Cr_{0.5}Fe_{0.5}Ni_{0.5})Se₂.

FIG. 33 represents a state density curve in an antiferromagnetic state obtained by conducting the first principle electronic state calculation of zinc blende type (Ti_{0.5}Cr_{0.5}Fe_{0.5}Ni_{0.5})Se₂. In the figure, a solid line represents a total state density, and a dotted line and two broken lines and a dashed line represent, local state densities at a 3d orbital position of Fe, Ni, Ti and Cr, respectively.

From a state density curve shown with a solid line in the figure, it can be said that a half-metallic property is developed. Furthermore, since Se that is a chalcogen is divalent, the numbers of effective d electrons of Ti and Cr are 2 and 4, respectively, and the number of effective d electrons of Ti_{0.5}Cr₀₅ is 3. On the other hand, since the numbers of effective d electrons of Fe and Ni are 6 and 8, respectively, the number of effective d electrons Fe_{0.5}Ni_{0.5} is 7. Accordingly, the total number of effective d electrons of Ti and Cr and Ni and Fe is 10. When a total state density of spin-up electrons and a total state density of spin-down electrons were each integrated up to the Fermi energy, both integral values were the same; accordingly, it can be said that magnetic moment of Ni and Fe and magnetic moment of Ti and Cr cancel out each other and thereby magnetization as a whole is zero.

From the result mentioned above, it can be said that the intermetallic compound of the present Example has a half-metallic antiferromagnetic property.

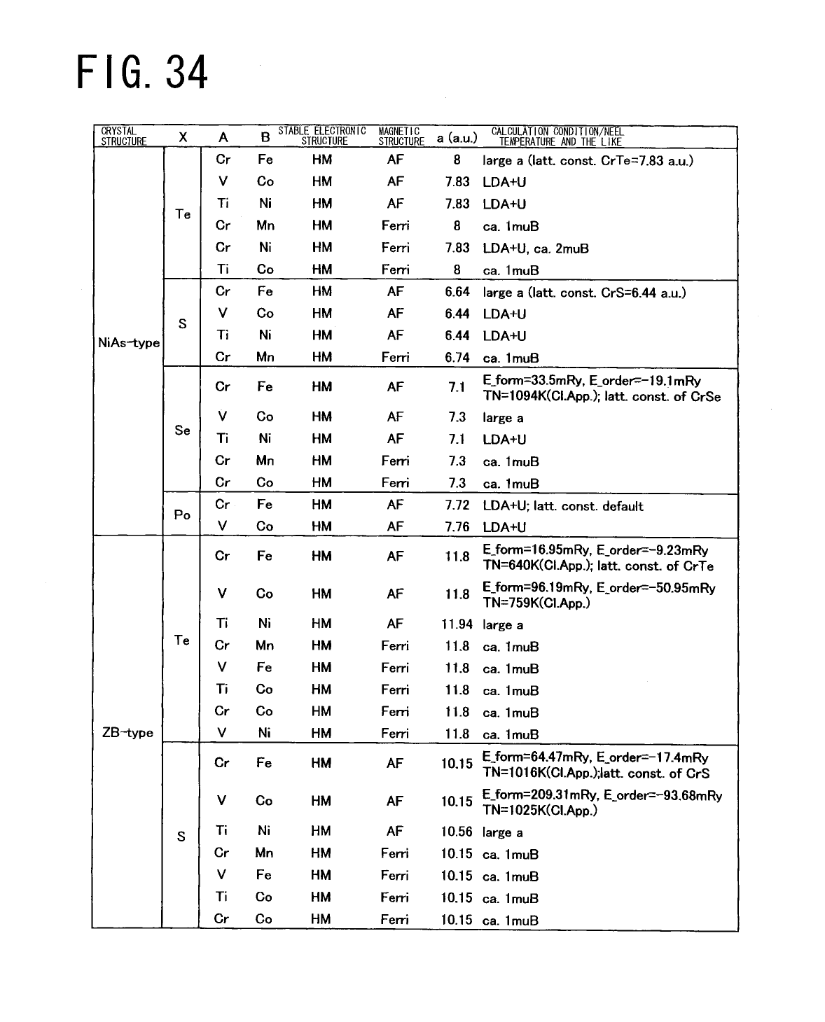

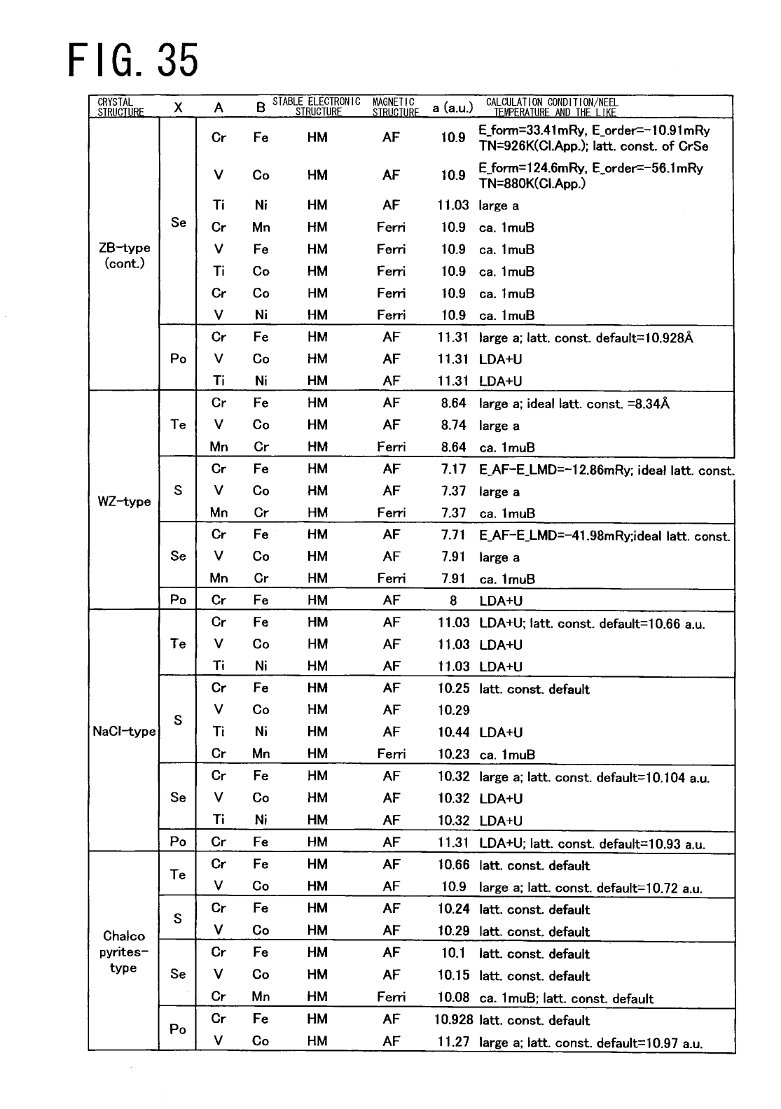

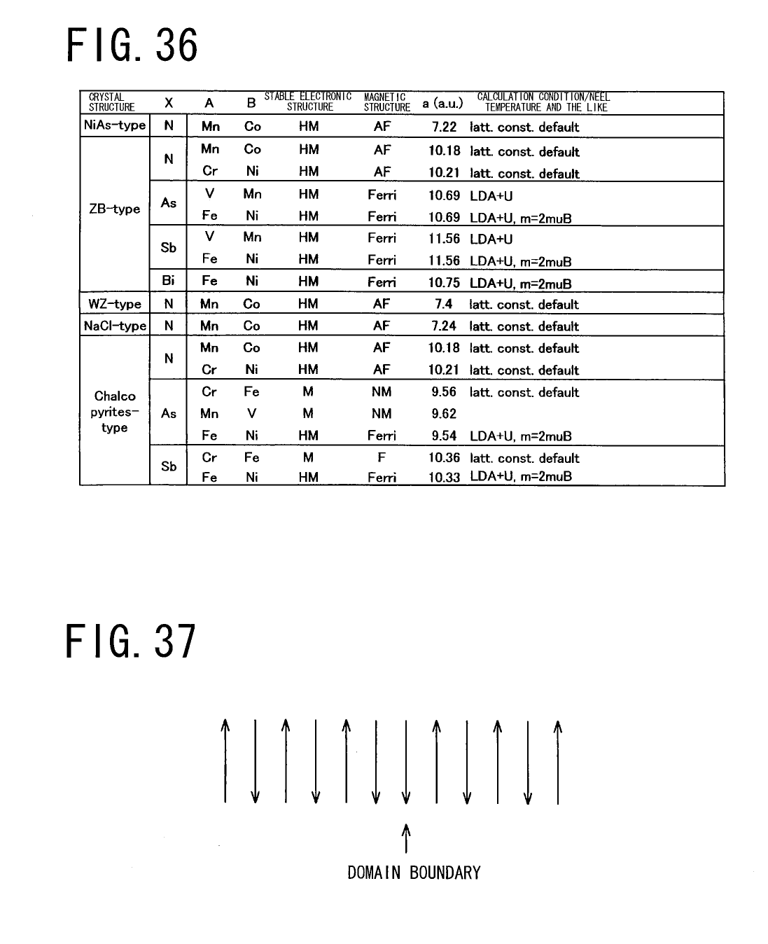

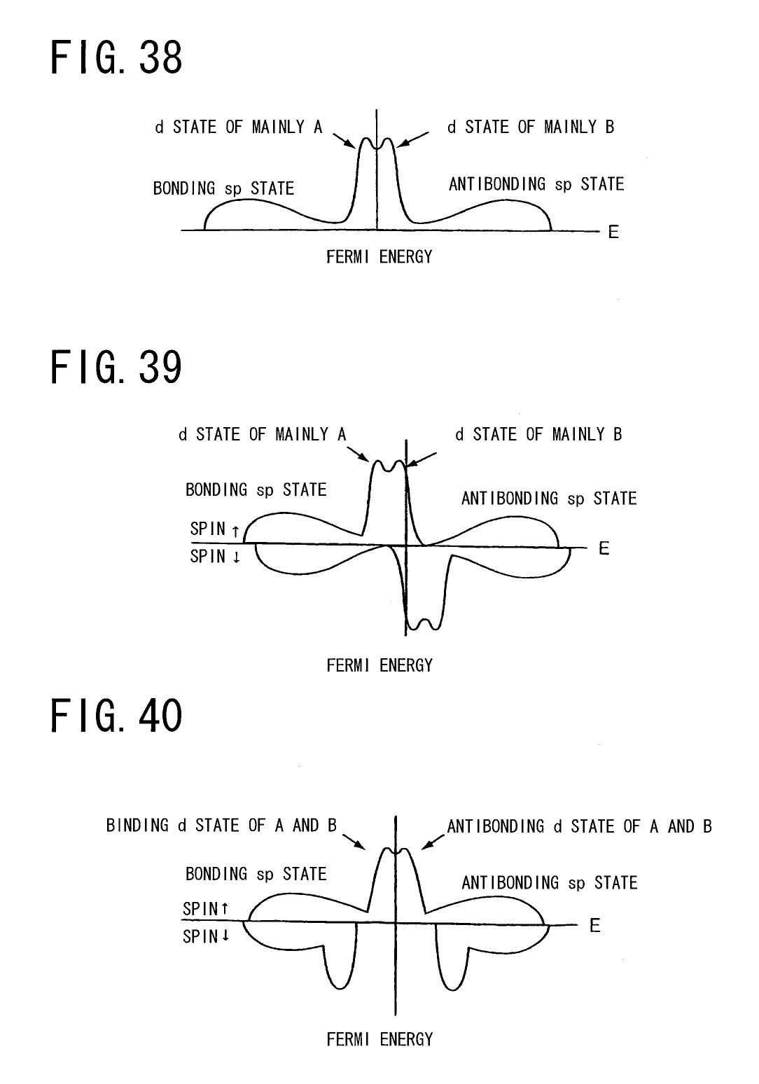

In FIGS. 34 to 36, results of the first principle electronic state calculation of various intermetallic compounds ABX₂ including intermetallic compounds of the first to the thirty examples are shown. In the figures and tables, “HM” and “M” represent half-metallic and ordinary metal, respectively. “AF”, “F”, “Fermi” and “NM” represent to be anti ferromagnetic, ferromagnetic, ferrimagnetic and nonmagnetic, respectively. Whether an intermetallic compound has an antiferromagnetic or ferromagnetic structure can be determined by calculating the sum of kinetic energy of electrons in the respective states from state density curves in a ferromagnetic state and an antiferromagnetic state obtained from the first principle electronic state calculation. That is, a state where the sum total of the kinetic energy of electrons is smallest is the most stable state and it can be said that an intermetallic compound has a magnetic structure in the most stable state. Furthermore, “a” represents a lattice constant, “muB” represents μ_{B} (Bohr magneton), “E_form” represents a formation energy of a compound, “E_order represents an ordering energy, “TN” represents a Neel temperature, and “Cl.App” means that when the Neel temperature is calculated, a Cluster approximation is adopted. Furthermore, “latt. const. default” means that a lattice constant corresponding to a volume determined from an ionic radius of each ion is used. Still furthermore, for example, “latt. const. default=10.928 a.u.” means that a lattice constant is set at 10.928, “latt. const. CrTe=7.83 a.u.” means that a lattice constant of CrTe is set at 7.83, and “latt. const. of CrSe” means that a lattice constant of CrSe is used.

For example, as to CrFeSe₂, as mentioned above, since Se that is a chalcogen is divalent, the numbers of effective d electrons of Cr and Fe are 4 and 6, respectively, and the total number of effective d electrons is 10. CrFeSe₂ exhibits, as shown in the figures and tables, a half-metallic antiferromagnetic property even in the case where CrFeSe₂ has any of crystal structures of a nickel arsenic type, a zinc blende type, a wurtzite type, a rock salt type and a chalcopyrite type.

Furthermore, the Neel temperatures of nickel arsenic type CrFeSe₂, zinc blende type CrFeTe₂, zinc blende type VCoTe₂, zinc blende type CrFeS₂, zinc blende type VCoS₂, zinc blende type CrFeSe₂ and zinc blende type VCoSe₂ are 1094K, 640K, 759K, 1016K, 1025K, 926K and 880K, respectively, that is, values far higher than room temperature. The Neel temperature of an antiferromagnetic half-metallic semiconductor is several hundreds K at the highest and several tens k at the lowest, and, according to nickel arsenic type CrFeSe₂, zinc blende type CrFeS₂, zinc blende type VCoS₂ and zinc blende type CrFeSe₂, the Neel temperature higher than that of an antiferromagnetic half-metallic semiconductor can be obtained. It is considered that also of intermetallic compounds other than the foregoing seven intermetallic compounds, the Neel temperature exceeding room temperature can be obtained.

As illustrated in the figures and tables, among intermetallic compounds to which the first principle electronic state calculation was conducted, intermetallic compounds exhibiting a ferrimagnetic property are contained. However, it is considered that, when conditions such as a concentration of magnetic elements are controlled, the likelihood of developing antiferromagnetic property is high.

In addition, among the intermetallic compounds illustrated in the figures and tables, nickel arsenic type CrFeSe₂, zinc blende type CrFeTe₂, zinc blende type VCoTe₂, zinc blende type CrFeS₂, zinc blende type VCoS₂, zinc blende type CrFeSe₂, zinc blende type VCoSe₂, wurtzite type CrFeS₂, wurtzite type CrFeSe₂, rock salt type CrFeS₂, chalcopyrite type CrFeTe₂, chalcopyrite type CrFeS₂, chalcopyrite type VCoS₂, chalcopyrite type CrFeSe₂, chalcopyrite type VCoSe₂ and chalcopyrite type CrFePo₂ exist energetically very stably, can obtain enough high Neel temperature and are harmless substances; accordingly, these intermetallic compounds are considered very promising as the half-metallic antiferromagnetic material.

Furthermore, the present inventors conducted the first principle electronic state calculation also of zinc blende type Co(Ti_{0.5}Cr_{0.5})X₂, zinc blende type V(Fe_{0.5}Ni_{0.5})X₂, zinc blende type (Ti_{0.5}Cr_{0.5})(Ni_{0.5}Fe_{0.5})X₂, zinc blende type Fe(Mn_{0.5}V_{0.5})X₂, zinc blende type Cr(Mn_{0.5}Co_{0.5})X₂, zinc blende type (Mn_{0.5}Vo_{0.5})(Co_{0.5}Mn_{0.5})X₂, nickel arsenic type Co(Ti_{0.5}Cr_{0.5})X₂, nickel arsenic type V(Ni_{0.5}Fe_{0.5})X₂, nickel arsenic type (Ti_{0.5}Cr_{0.5})(Ni_{0.5}Fe_{0.5})X₂, chalcopyrite type Co (Ti_{0.5}Cr_{0.5})X₂, chalcopyrite type V(Ni_{0.5}Fe_{0.5})X₂, chalcopyrite type (Ti_{0.5}Cr_{0.5})(Ni_{0.5}Fe_{0.5})X₂, wurtzite type V(Fe_{0.5}Mn_{0.5})X₂, wurtzite type (V_{0.5}Mn_{0.5})(Mn_{0.5}Co_{0.5})X₂ and rock salt type Co(Ti_{0.5}Cr_{0.5})X₂, all of which contains a chalcogen X (X is Se, Po, Te or S), and confirmed that all intermetallic compounds have a half-metallic antiferromagnetic property. Furthermore, the first principle electronic state calculation was conducted also of zinc blende type Co(Fe_{0.5}Cr_{0.5})N₂ containing a pnictogen and confirmed that it has a half-metallic antiferromagnetic property.

In addition, as combinations between two or more magnetic elements and a chalcogen or a pnictogen, also others than the foregoing combinations to which the first principle electronic state calculation was conducted are considered to have likelihood of developing a half-metallic antiferromagnetic property.

As mentioned above, the half-metallic antiferromagnetic materials according to the present invention have a stable magnetic structure that is chemically stable and has the Neel temperature far higher than room temperature. Accordingly, a device that uses the half-metallic antiferromagnetic material can operate stably at room temperature.

1-4. (canceled)

5. A half-metallic antiferromagnetic material comprising:
two or more magnetic elements; and
a chalcogen or a pnictogen,
wherein the two or more magnetic elements contains a magnetic element having fewer than 5 effective d electrons and a magnetic element having more than 5 effective d electrons, and a total number of effective d electrons of the two or more magnetic elements is 10 or a value close to 10.

6. The half-metallic antiferromagnetic material according to claim 5, wherein the half-metallic antiferromagnetic material is a compound having a nickel arsenic type crystal structure, a zinc blende type crystal structure, a wurtzite type crystal structure, a chalcopyrite type crystal structure or a rock salt type crystal structure.

7. The half-metallic antiferromagnetic material according to claim 5, comprising:
two magnetic elements; and
a chalcogen.

8. The half-metallic antiferromagnetic material according to claim 7, wherein the two magnetic elements are any one combination selected from the groups of Cr and Fe, V and Co, Ti and Ni, Cr and Mn, Cr and Ni, Ti and Co, Cr and Co, V and Fe, and V and Ni.

9. The half-metallic antiferromagnetic material according to claim 5, comprising:
three magnetic elements; and
a chalcogen.

10. The half-metallic antiferromagnetic material according to claim 9, wherein the three magnetic elements are any one combination selected from the groups of Co and Ti and Cr, V and Fe and Ni, Fe and Mn and V, Cr and Mn and Co, and Mn and V and Co.

11. The half-metallic antiferromagnetic material according to claim 5, comprising:
four magnetic elements; and
a chalcogen.

12. The half-metallic antiferromagnetic material according to claim 11, wherein the four magnetic elements are Ti and Cr and Fe and Ni.

13. The half-metallic antiferromagnetic material according to claim 5 wherein the chalcogen is any element of S, Se, Te or Po.

14. The half-metallic antiferromagnetic material according to claim 5, comprising:
two magnetic elements; and
a pnictogen.

15. The half-metallic antiferromagnetic material according to claim 14, wherein the two magnetic elements are any one combination selected from the groups of Mn and Co, Cr and Ni, V and Mn and Fe and Ni.

16. The half-metallic antiferromagnetic material according to claim 5, comprising:
three magnetic elements; and
a pnictogen.

17. The half-metallic antiferromagnetic material according to claim 16, wherein the three magnetic elements are Co and Fe and Cr.

18. The half-metallic antiferromagnetic material according to claim 5, wherein the pnictogen is any element of N, As, Sb or Bi.
